(19) United States
(12) Patent Application Publication
(10) Pub. No.: US 2013/0201394 A1
(43) Pub. Date: Aug. 8, 2013

(54) ZOOM LENS AND IMAGE PICKUP APPARATUS

(71) Applicant: SONY CORPORATION, Tokyo (JP)

(72) Inventor: Takeshi Hatakeyama, Chiba (JP)

(73) Assignee: SONY CORPORATION, Tokyo (JP)

(21) Appl. No.: 13/832,707

(22) Filed: Mar. 15, 2013

Related U.S. Application Data
(63) Continuation-in-part of application No. 12/658,416, filed on Feb. 8, 2010.

(30) Foreign Application Priority Data
Feb. 18, 2009 (JP) P2009-035830

(51) Int. Cl. G02B 15/14; G02B 27/64

(52) U.S. Cl. CPC G02B 15/14; G02B 27/646
USPC 348/445; 359/684; 359/557

(57) ABSTRACT

A zoom lens and an image pickup apparatus having such a zoom lens are provided. The zoom lens includes a first lens group in which each lens has negative refractive power, a second lens group in which each lens has positive refractive power, a third lens group in which each lens has positive refractive power. These lens groups are arranged in this order from an object side to an image side. The first lens group includes a negative lens and a positive lens which are arranged in this order from an image side to an object side. The third lens group includes a positive lens. Both surfaces of the negative lens of the first lens group are aspherical surfaces, respectively. Both surfaces of the positive surfaces of the third lens group are aspherical surfaces, respectively.

### CROSS-REFERENCE TO RELATED APPLICATION

The present application is a continuation-in-part of U.S. patent application Ser. No. 12/658,416, filed on Feb. 8, 2010, which claims priority from Japanese Patent Application No. JP 2009-035830, filed in the Japanese Patent Office on Feb. 18, 2009, all of which are incorporated herein by reference.

### BACKGROUND OF THE INVENTION

1. Field of the Invention

The present invention relates to a zoom lens and an image pickup apparatus. In particular, the present invention relates to the technical fields of a zoom lens to be used in a digital still camera, a digital video camera, or the like, which is excellent in thickness direction in a depth direction while having a wide-angle and high zooming ratio of the focal length at a wide-angle length and being superior in correction of field curvature, and to an image pickup apparatus having such a zoom lens.

2. Description of the Related Art

In recent years, image pickup apparatuses using a solid-state imaging device with a large number of pixels, such as digital still cameras and digital video cameras, have become increasingly popular, demanding still higher image quality and thickness reduction. Under such a situation, in particular, a zoom lens installed in the image pickup apparatus has been demanded to have a longer focal length at a wide-angle end; a high zooming ratio; an excellent image forming performance over the entire range from a wide-angle to telephoto end and from an infinite-distance to near-distance imaging; and a reduced thickness in a depth direction.

In recent years, to realize a thickness reduction of the image pickup apparatus, a so-called retractable lens system has been mainly employed. The retractable lens system is an optical system to be protruded from the main body of the apparatus at the time of shooting and housed therein at the time of non-shooting. However, the retractable lens system may cause an increase in thickness due to the lens configuration at the time of housing.

As a zoom lens suitable for the small digital still camera, for example, many zoom lenses have been proposed so that each of them is constructed of three lens groups, a first lens group having a negative refractive power, a second lens group having a positive refractive power, and a third lens group having a positive refractive power, arranged in this order in the direction from an object side to an image side.

Some of the zoom lenses with such a three-group constitution, which are applicable to an image pickup apparatus with a large number of pixels, have increased zooming ranges and are able to ensure the entire range from a wide-angle to telephoto end and from an infinite-distance to near-distance imaging (see, for example, Japanese Unexamined Patent Application Publication Nos. 11-194274, 2002-90624, and 11-287953).

In addition, there is another kind of the zoom lens which can be further miniaturized by electrical image processing of image data captured by a solid-state imaging device (see, for example, Japanese Unexamined Patent Application Publication No. 2006-284790).

### SUMMARY OF THE INVENTION

However, to obtain an increased zooming range, the zoom lens described in Japanese Unexamined Patent Application Publication No. 11-194274 is provided with a second lens group of a four-lens construction by assembling four lenses into the second lens group. In this case, however, four lenses are high in number for the second lens, so that the thickness of the second lens group will be large in size and a size reduction thereof at the time of housing will be hardly attained.

In addition, the zoom lens described in Japanese Unexamined Patent Application Publication No. 2002-90624 intends to obtain an increased zooming range by providing a typical zoom lens having three lens groups with an additional lens group, a fourth lens group. This additional lens group is a fixed group to be effective in correction of off-axis aberration. However, because of an increase in number of lenses, a thickness reduction is hardly attained at the time of housing.

Further, the zoom lens described in Japanese Unexamined Patent Application Publication No. 11-287953 performs focusing during near-distance imaging by moving the first lens group in an optical axis direction. However, the first lens group has a large lens diameter, so that the driving mechanism of the lens group can be also enlarged. Thus, sufficient miniaturization of the zoom lens can be hardly attained. Furthermore, the first lens group is constructed of three lenses. In particular, it will interfere with thickness reduction at the time of housing.

In addition, the zoom lens described in Japanese Unexamined Patent Application Publication No. 2006-284790 is made smaller by designing the zoom lens to perform electric image processing of image data to enhance the negative refractive power of the first lens. In this case, however, it leads to a decrease in optical performance due to increased variations of off-axis aberrations, such as astigmatism and field curvature, occurred at the time of a change in distance of an object on the telephoto end side.

In the light of the above situations, it is desirable to shorten a focal length at a wide angle end to attain a wider angle and obtain the increased zooming range so that good image forming performance can be ensured in the entire range from a wide-angle to telephoto end and from an infinite-distance to near-distance imaging to reduce the thickness of the zoom lens.

According to an embodiment of the present invention, a zoom lens includes a first lens group having negative refractive power, a second lens group having positive refractive power, and a third lens group having positive refractive power which are arranged in order from an object side to an image side and configured as follows: In the zoom lens, when a positional lens state is changed from a wide angle end state to a telephoto end state, the second lens group moves toward an object in an optical axis direction and both the first lens group and the third lens group move in the optical axis direction to reduce the spacing between the first lens group and the second lens group and to increase the spacing between the second lens group and the third lens group. In the zoom lens, furthermore, a focusing function performed by movement of the third lens group is performed by the movement of the third lens group in the optical axis direction at the time of changing the object position. In the zoom lens, furthermore, the first lens group includes a negative lens and a positive lens which are arranged in this order from an image side to an object side. The third lens group includes a positive lens. Both surfaces of the negative lens of the first lens group are aspherical surfaces, respectively. In addition, both surfaces of the positive surfaces of the third lens group are aspherical surfaces, respectively.

Therefore, the zoom lens according to the embodiment of the present invention includes two lenses in the first group and one lens in the third lens group.

In the above zoom lens, preferably, the second lens group may include two positive lenses and one negative lens.

By constructing the second lens group from two positive lenses and one negative lens, spherical aberration, astigmatism, chromatic aberration, and so on can be corrected by a smaller number of lenses.

Preferably, the above zoom lens may have at least one aspherical surface in the second lens group.

By providing the second lens group with at least one aspherical surface, the spherical surface may exert functions of correcting aberrations, such as spherical aberration, astigmatism, and chromatic aberration.

Preferably, in the above zoom lens, the second lens group may be designed to be shifted substantially in the direction perpendicular to the optical axis to shift an image.

The image shift can be performed using a lightweight second lens group with a comparatively small lens diameter as the second lens group is designed to be shifted substantially in the direction perpendicular to the optical axis to shift the image.

According to another embodiment of the present invention, an image pickup apparatus includes a zoom lens and an imaging device that converts an optical image formed by the zoom lens into an electrical signal and the zoom lens is configured as follows: The zoom lens includes a first lens group having negative refractive power, a second lens group having positive refractive power, and a third lens group having positive refractive power which are arranged in this order from an object side to an image side. In this zoom lens, when a positional lens state is changed from a wide angle end state to a telephoto end state, the second lens group moves toward an object in an optical axis direction and both the first lens group and the third lens group move in the optical axis direction to reduce the spacing between the first lens group and the second lens group and to increase the spacing between the second lens group and the third lens group. In the zoom lens, furthermore, a focusing function performed by movement of the third lens group is performed by the movement of the third lens group in the optical axis direction at the time of changing the object position.

The first lens group includes a negative lens and a positive lens which are arranged in this order from an image side to an object side. In the zoom lens, furthermore, the third lens group includes a positive lens. Both surfaces of the negative lens of the first lens group are aspherical surfaces, respectively. In addition, both surfaces of the positive surfaces of the third lens group are aspherical surfaces, respectively.

Therefore, the zoom lens in the image pickup apparatus according to the embodiment of the present invention includes two lenses of the first group and one lens of the third lens group.

As described above, the zoom lens according to any of the embodiments of the present invention includes the first lens group having negative refractive power, the second lens group having positive refractive power, and the third lens group having positive refractive power. These lens groups are arranged in that order from the object side to the image side. When a positional lens state is changed from a wide angle end state to a telephoto end state, the second lens group moves toward an object in an optical axis direction and both the first lens group and the third lens group move in the optical axis direction to reduce the spacing between the first lens group and the second lens group and to increase the spacing between the second lens group and the third lens group. Then, a focusing function performed by movement of the third lens group is performed by the movement of the third lens group in the optical axis direction at the time of changing the object position. In the zoom lens, as described above, the first lens group includes a negative lens and a positive lens which are arranged in this order from an object side to an image side. In addition, the third lens group includes a positive lens. Both surfaces of the negative lens of the first lens group are aspherical surfaces, respectively. Both surfaces of the positive lens of the third lens group are aspherical surfaces, respectively. Therefore, the zoom lens satisfies the following conditional expressions (1) to (4):

0.10<ASPa1<0.36; (1)

−0.05<ASPa2<−0.02; (2)

0<ASPb1<0.20; and (3)

0.04<ASPb2<0.15, wherein (4)

ASPa1=(ZAa1−ZRa1)/{Ca1(Na−1)·f1},

ASPa2=(ZAa2−ZRa2)/{Ca2(1−Na)·f1},

AsPb1=(ZAb1−ZRb1)/{Cb1(Nb−1)·f3},

AsPb2=(ZAb2−ZRb2)/{Cb2(1−Nb)·f3},

Da: thickness of the negative lens on the optical axis of the first lens group,

Db: thickness of the positive lens on the optical axis of the third lens group,

Ya=4Da,

Yb=2 Db,

ZRa1: coordinate in the optical axis direction at a height corresponding to Ya from the optical axis of an object-side paraxial curvature surface of the negative lens in the first lens group,

ZRa2: coordinate in the optical axis direction at a height corresponding to Ya from the optical axis of an image-side paraxial curvature surface of the negative lens in the first lens group;

ZAa1: coordinate in the optical axis direction at a height corresponding to Ya from the optical axis of an object-side aspherical surface of the negative lens in the first lens group,

ZAa2: coordinate in the optical axis direction at a height corresponding to Ya from the optical axis of an image-side aspherical surface of the negative lens in the first lens group,

Ca1: paraxial curvature of the object-side aspherical surface of the negative lens in the first lens group,

Ca2: paraxial curvature of the image-side aspherical surface of the negative lens in the first lens group,

Na: refractive index to the e-line of the negative lens in the first lens group,

f1: focal length of the first lens group,

ZRb1: coordinate in the optical axis direction at a height corresponding to Yb from the optical axis of an object-side paraxial curvature surface of the positive lens in the third lens group,

ZRb2: coordinate in the optical axis direction at a height corresponding to Yb from the optical axis of an image-side paraxial curvature surface of the positive lens in the third lens group,

ZAb1: coordinate in the optical axis direction at a height corresponding to Yb from the optical axis of an object-side aspherical surface of the positive lens in the third lens group,

ZAb2: coordinate in the optical axis direction at a height corresponding to Yb from the optical axis of an image-side aspherical surface of the positive lens in the third lens group,

Cb1: paraxial curvature of the object-side aspherical surface of the positive lens in the third lens group;

Cb2: paraxial curvature of the image-side aspherical surface of the positive lens in the third lens group;

Nb: refractive index to the e-line of the positive lens in the third lens group, and

f3: focal length of the third lens group.

Therefore, the focal length at a wide-angle end can be shortened to obtain a wider angle and an increased zooming range can be attained. In addition, good image forming performance can be ensured in the entire range from a wide-angle to telephoto end and from an infinite-distance to near-distance imaging. Therefore, thickness reduction can be attained.

In the zoom lens according to a second embodiment of the present invention, the second lens group includes two positive lenses and one negative lens.

Therefore, spherical aberration, astigmatism, chromatic aberration, and so on can be corrected using a smaller number of lenses. In addition, thickness reduction of a zoom lens can be attained.

In the zoom lens according to each of third and fourth embodiments of the present invention, at least one surface of the lens in the second lens group has an aspherical surface.

Therefore, spherical aberration, astigmatism, chromatic aberration, and so on can be further corrected using a smaller number of lenses. In addition, high image quality can be attained.

In the zoom lens according to each of fifth and eighth embodiments of the present invention, the second lens group can be shifted substantially in the direction perpendicular to the optical axis to shift an image.

Therefore, since the second lens group is lightweight and the lens diameter thereof is small, a drive mechanism for vibration control can be minimized.

The image pickup apparatus of the embodiment of the present invention includes a zoom lens and an imaging device that converts an optical image formed by the zoom lens into an electrical signal. The zoom lens includes a first lens group having negative refractive power, a second lens group having positive refractive power, and a third lens group having positive refractive power which are arranged in this order from an object side to an image side.

When a positional lens state is changed from a wide angle end state to a telephoto end state, the second lens group moves toward an object in an optical axis direction and both the first lens group and the third lens group move in the optical axis direction to reduce the spacing between the first lens group and the second lens group and to increase the spacing between the second lens group and the third lens group. Then, a focusing function performed by movement of the third lens group is performed by the movement of the third lens group in the optical axis direction at the time of changing the object position. In the zoom lens, as described above, the first lens group includes a negative lens and a positive lens which are arranged in this order from an object side to an image side. In addition, the third lens group includes a positive lens. Both surfaces of the negative lens of the first lens group are aspherical surfaces, respectively.

Both surfaces of the positive lens of the third lens group are aspherical surfaces, respectively. Therefore, the zoom lens satisfies the following conditional expressions (1) to (4):

0.10<ASPa1<0.36; (1)

−0.05<ASPa2<−0.02; (2)

0<ASPb1<0.20; and (2)

0.04<ASPb2<0.15, wherein (4)

ASPa1=(ZAa1−ZRa1)/{Ca1(Na−1)·f1},

ASPa2=(ZAa2−ZRa2)/{Ca2(1−Na)·f1},

AsPb1=(ZAb1−ZRb1)/{Cb1(Nb−1)·f3},

AsPb2=(ZAb2−ZRb2)/{Cb2(1−Nb)·f3},

Da: thickness of the negative lens on the optical axis of the first lens group,

Db: thickness of the positive lens on the optical axis of the third lens group,

Ya=4Da,

Yb=2 Db,

ZRa1: coordinate in the optical axis direction at a height corresponding to Ya from the optical axis of an object-side paraxial curvature surface of the negative lens in the first lens group.

ZRa2: coordinate in the optical axis direction at a height corresponding to Ya from the optical axis of an image-side paraxial curvature surface of the negative lens in the first lens group;

ZAa1: coordinate in the optical axis direction at a height corresponding to Ya from the optical axis of an object-side aspherical surface of the negative lens in the first lens group,

ZAa2: coordinate in the optical axis direction at a height corresponding to Ya from the optical axis of an image-side aspherical surface of the negative lens in the first lens group,

Ca1: paraxial curvature of the object-side aspherical surface of the negative lens in the first lens group,

Ca2: paraxial curvature of the image-side aspherical surface of the negative lens in the first lens group,

Na: refractive index to the e-line of the negative lens in the first lens group,

f1: focal length of the first lens group,

ZRb1: coordinate in the optical axis direction at a height corresponding to Yb from the optical axis of an object-side paraxial curvature surface of the positive lens in the third lens group,

ZRb2: coordinate in the optical axis direction at a height corresponding to Yb from the optical axis of an image-side paraxial curvature surface of the positive lens in the third lens group,

ZAb1: coordinate in the optical axis direction at a height corresponding to Yb from the optical axis of an object-side aspherical surface of the positive lens in the third lens group,

ZAb2: coordinate in the optical axis direction at a height corresponding to Yb from the optical axis of an image-side aspherical surface of the positive lens in the third lens group,

Cb1: paraxial curvature of the object-side aspherical surface of the positive lens in the third lens group;

Cb2: paraxial curvature of the image-side aspherical surface of the positive lens in the third lens group;

Nb: refractive index to the e-line of the positive lens in the third lens group, and

f3: focal length of the third lens group.

Therefore, the focal length at a wide-angle end can be shortened to obtain a wider angle and an increased zooming range can be attained. In addition, good image forming performance can be ensured in the entire range from a wide-angle to telephoto end and from an infinite-distance to near-distance imaging. Therefore, thickness reduction can be attained.

Especially, in the case of using a retractable lens type image pickup apparatus in which an optical system can be protruded from and housed in the main body of the apparatus, thickness reduction at the time of housing an optical system can be attained.

### BRIEF DESCRIPTION OF THE DRAWINGS

FIG. 1 is a diagram illustrating a lens arrangement in a zoom lens according to a first embodiment of the present invention, representing the best mode for carrying out an image pickup apparatus and the zoom lens in a manner similar to FIG. 2 to FIG. 26;

FIG. 2 is a diagram illustrating spherical aberration, astigmatism, and distortion aberration during the infinite distance focusing in a wide-angle end state, representing an aberration graph of a numerical example in which concrete numerical values are applied to the first embodiment in a manner similar to FIG. 3 to FIG. 5;

FIG. 3 is a diagram illustrating spherical aberration, astigmatism, and distortion aberration during the infinite distance focusing in a middle focal position state;

FIG. 4 is a diagram illustrating spherical aberration, astigmatism, and distortion aberration during the infinite distance focusing in a telephoto end state;

FIG. 5 is a diagram illustrating spherical aberration, astigmatism, and distortion aberration during the focusing with an object distance of 2 m in the telephoto angle end state;

FIG. 6 is a diagram illustrating a lens arrangement in a zoom lens according to a second embodiment of the present invention;

FIG. 7 is a diagram illustrating spherical aberration, astigmatism, and distortion aberration during the infinite distance focusing in a wide-angle end state, representing an aberration graph of a numerical example in which concrete numerical values are applied to the first embodiment in a manner similar to FIG. 8 to FIG. 10;

FIG. 8 is a diagram illustrating spherical aberration, astigmatism, and distortion aberration during the infinite distance focusing in a middle focal position state;

FIG. 9 is a diagram illustrating spherical aberration, astigmatism, and distortion aberration during the infinite distance focusing in a telephoto end state;

FIG. 10 is a diagram illustrating spherical aberration, astigmatism, and distortion aberration during the focusing with an object distance of 2 m in the telephoto angle end state;

FIG. 11 is a diagram illustrating a lens arrangement in a zoom lens according to a third embodiment of the present invention;

FIG. 12 is a diagram illustrating spherical aberration, astigmatism, and distortion aberration during the infinite distance focusing in a wide-angle end state, representing an aberration graph of a numerical example in which concrete numerical values are applied to the first embodiment in a manner similar to FIG. 13 to FIG. 15;

FIG. 13 is a diagram illustrating spherical aberration, astigmatism, and distortion aberration during the infinite distance focusing in a middle focal position state;

FIG. 14 is a diagram illustrating spherical aberration, astigmatism, and distortion aberration during the infinite distance focusing in a telephoto end state;

FIG. 15 is a diagram illustrating spherical aberration, astigmatism, and distortion aberration during the focusing with an object distance of 2 m in the telephoto angle end state;

FIG. 16 is a diagram illustrating a lens arrangement in a zoom lens according to a fourth embodiment of the present invention;

FIG. 17 is a diagram illustrating spherical aberration, astigmatism, and distortion aberration during the infinite distance focusing in a wide-angle end state, representing an aberration graph of a numerical example in which concrete numerical values are applied to the fourth embodiment in a manner similar to FIG. 18 to FIG. 20;

FIG. 18 is a diagram illustrating spherical aberration, astigmatism, and distortion aberration during the infinite distance focusing in a middle focal position state;

FIG. 19 is a diagram illustrating spherical aberration, astigmatism, and distortion aberration during the infinite distance focusing in a telephoto end state;

FIG. 20 is a diagram illustrating spherical aberration, astigmatism, and distortion aberration during the focusing with an object distance of 2 m in the telephoto angle end state;

FIG. 21 is a diagram illustrating a lens arrangement in a zoom lens according to a fifth embodiment of the present invention;

FIG. 22 is a diagram illustrating spherical aberration, astigmatism, and distortion aberration during the infinite distance focusing in a wide-angle end state, representing an aberration graph of a numerical example in which concrete numerical values are applied to the fifth embodiment in a manner similar to FIG. 23 to FIG. 25;

FIG. 23 is a diagram illustrating spherical aberration, astigmatism, and distortion aberration during the infinite distance focusing in a middle focal position state;

FIG. 24 is a diagram illustrating spherical aberration, astigmatism, and distortion aberration during the infinite distance focusing in a telephoto end state;

FIG. 25 is a diagram illustrating spherical aberration, astigmatism, and distortion aberration during the focusing with an object distance of 2 m in the telephoto angle end state; and

FIG. 26 is a block diagram illustrating an image pickup apparatus according to one of embodiments of the present invention.

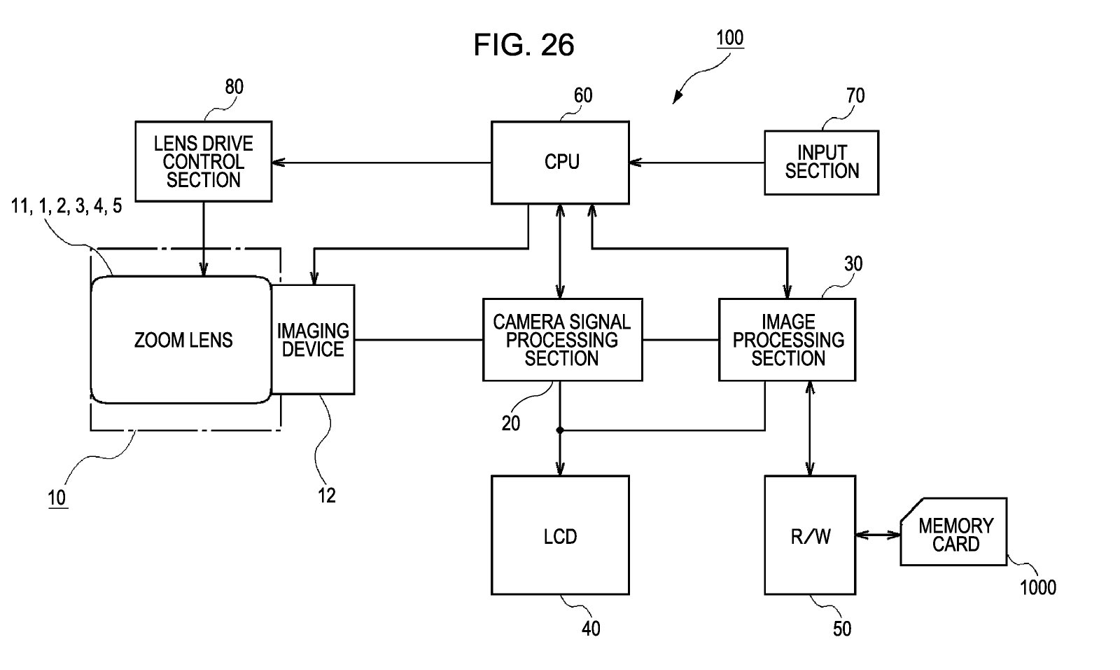

### DESCRIPTION OF THE PREFERRED EMBODIMENTS

Hereinafter, the zoom lens and the image pickup apparatus according to the embodiments of the present invention will be described with reference to the attached drawings.

### [Configuration of Zoom Lens]

First, a zoom lens according to one of the embodiments of the present invention will be descried.

The zoom lens according to the embodiment of the present invention includes a first lens group having negative refractive power, a second lens group having positive refractive power, and a third lens group having positive refractive power which are arranged in order from an object side to an image side.

In the zoom lens of the present embodiment, when a positional lens state is changed from a wide angle end state to a telephoto end state, the second lens group moves toward an object in an optical axis direction and both the first lens group and the third lens group move in the optical axis direction to reduce the spacing between the first lens group and the second lens group and to increase the spacing between the second lens group and the third lens group.

In the zoom lens of the present embodiment, furthermore, a focusing function performed by movement of the third lens group is performed by the movement of the third lens group in the optical axis direction at the time of changing the object position

In the zoom lens of the present embodiment, furthermore, the first lens group includes a negative lens and a positive lens which are arranged in this order from an image side to an object side. The third lens group includes a positive lens. Both surfaces of the negative lens of the first lens group are aspherical surfaces, respectively. Both surfaces of the positive lens of the third lens group are aspherical surfaces, respectively.

In the zoom lens of the present embodiment, as described above, the first lens group includes a negative lens and a positive lens, where both surfaces of each lens are aspherical surfaces. The third lens group includes a positive lens where both surfaces thereof are aspherical surfaces.

Therefore, the number of lenses in each of the lens groups is set to the minimal number of lenses enough to favorably correct spherical aberration, astigmatism, chromatic aberration, and so on. Thickness reduction, especially, in the case of using a retractable lens type image pickup apparatus in which an optical system can be protruded from and housed in the main body of the apparatus, thickness reduction at the time of housing an optical system can be attained.

The zoom lens of the present embodiment is constructed to satisfy the following conditional expressions (1) to (4):

0.10<ASPa1<0.36; (1)

−0.05<ASPa2<−0.02; (2)

0<ASPb1<0.20; and (3)

0.04<ASPb2<0.15, wherein (4)

ASPa1=(ZAa1−ZRa1)/{Ca1(Na−1)·f1},

ASPa2=(ZAa2−ZRa2)/{Ca2(1−Na)·f1},

AsPb1=(ZAb1−ZRb1)/{Cb1(Nb−1)·f3},

AsPb2=(ZAb2−ZRb2)/{Cb2(1−Nb)·f3},

Da: thickness of the negative lens on the optical axis of the first lens group,

Db: thickness of the positive lens on the optical axis of the third lens group,

Ya=4Da,

Yb=2 Db,

ZRa1: coordinate in the optical axis direction at a height corresponding to Ya from the optical axis of an object-side paraxial curvature surface of the negative lens in the first lens group,

ZRa2: coordinate in the optical axis direction at a height corresponding to Ya from the optical axis of an image-side paraxial curvature surface of the negative lens in the first lens group;

ZAa1: coordinate in the optical axis direction at a height corresponding to Ya from the optical axis of an object-side aspherical surface of the negative lens in the first lens group,

ZAa2: coordinate in the optical axis direction at a height corresponding to Ya from the optical axis of an image-side aspherical surface of the negative lens in the first lens group,

Ca1: paraxial curvature of the object-side aspherical surface of the negative lens in the first lens group,

Ca2: paraxial curvature of the image-side aspherical surface of the negative lens in the first lens group,

Na: refractive index to the e-line of the negative lens in the first lens group,

f1: focal length of the first lens group,

ZRb1: coordinate in the optical axis direction at a height corresponding to Yb from the optical axis of an object-side paraxial curvature surface of the positive lens in the third lens group,

ZRb2: coordinate in the optical axis direction at a height corresponding to Yb from the optical axis of an image-side paraxial curvature surface of the positive lens in the third lens group,

ZAb1: coordinate in the optical axis direction at a height corresponding to Yb from the optical axis of an object-side aspherical surface of the positive lens in the third lens group,

ZAb2: coordinate in the optical axis direction at a height corresponding to Yb from the optical axis of an image-side aspherical surface of the positive lens in the third lens group,

Cb1: paraxial curvature of the object-side aspherical surface of the positive lens in the third lens group;

Cb2: paraxial curvature of the image-side aspherical surface of the positive lens in the third lens group;

Nb: refractive index to the e-line of the positive lens in the third lens group, and

f3: focal length of the third lens group. Furthermore, the above e-line has a wavelength of 546.07 nm.

If the value is lower than the lower limit of the conditional expression (1), the effect of the aspherical surface is hardly obtained. In this case, therefore, the spherical single lens becomes difficult to correct the aberration as an image plane results in underexposure on a wide-angle side. In particular, if the negative refracting power of the object-side surface of the negative lens in the first lens group is gradually strengthened, it becomes difficult to find a balance between the wide-angle side and the telescopic side with respect to the use of the positive lens in the third lens to collect an off-axis aberration occurred in the negative lens in the first lens group. As a result, the field curvature varies extensively when the subject distance varies on the telephoto end side.

On the other hand, if the value exceeds the upper limit of the conditional expression (1), then the effect of the aspherical surface becomes too strong. It becomes difficult to favorably correct the aberration because of resulting in results in over exposure on the wide angle side.

Therefore, as long as the zoom lens satisfies the conditional expression (1), the effect of the aspherical surface can be fairly exerted. Thus, good aberration compensation can be performed to improve the optical performance of the zoom lens.

If the value is lower than the lower limit of the conditional expression (2), the effect of the aspherical surface becomes too strong. In this case, therefore, the spherical single lens becomes difficult to correct the aberration as an image plane results in underexposure on a wide-angle side.

On the other hand, if the value exceeds the upper limit of the conditional expression (2), the effect of the aspherical surface is hardly obtained. It becomes difficult to favorably correct the aberration because of resulting in results in over exposure on the wide angle side. In particular, if the negative refracting power of the image-side surface of the negative lens in the first lens group is gradually strengthened, the curvature of the edge part of the lens becomes large. Therefore, a difficulty in formation a negative lens in the first lens group will increase.

Therefore, if the zoom lens satisfies the conditional expression (2), the effect of the aspherical surface can be fairly exerted. In this case, therefore, good aberration compensation is performed. As a result, an improvement of optical performance and a simplified formation of a negative lens in the first lens group can be attained.

If the value is lower than the lower limit of the conditional expression (3), the effect of the aspherical surface is hardly obtained. It becomes difficult to favorably correct the aberration because of resulting in results in over exposure on the telescopic side.

If the value exceeds the upper limit of the conditional expression (3), the effect of the aspherical surface becomes too strong and thus an image plane tends to result in underexposure on the telescopic side. In addition, since the correction effects of field curvature by the aspherical surface becomes too strong, the field curvature varies extensively when the subject distance varies on the telephoto end side.

Therefore, if the zoom lens satisfies the conditional expression (3), the effect of the aspherical surface can be fairly exerted. Good aberration compensation can be performed to improve the optical performance of the zoom lens.

If the value is lower than the lower limit of the conditional expression (4), the effect of the aspherical surface is hardly obtained. In this case, therefore, the spherical single lens becomes difficult to correct the aberration as an image plane results in underexposure on the telescopic side.

If the value exceeds the upper limit of the conditional expression (4), the effect of the aspherical surface becomes too strong and thus an image plane tends to result in over exposure on the telescopic side. In addition, since the correction effects of field curvature by the aspherical surface becomes too strong, the field curvature varies extensively when the subject distance varies on the telephoto end side.

Therefore, as long as the zoom lens satisfies the conditional expression (4), the effect of the aspherical surface can be fairly exerted. Good aberration compensation can be performed to improve the optical performance of the zoom lens.

In the zoom lens according to the embodiment of the present embodiment, it is preferable that the second lens group includes two positive lenses and one negative lens.

As the second lens group is constructed of two positive lenses and one negative lens, therefore, spherical aberration, astigmatism, chromatic aberration, and so on can be corrected using a smaller number of lenses and also the thickness reduction of the zoom lens can be attained.

In the zoom lens of the first embodiment of the present invention, it is preferable that at least one surface of the lens in the second lens group has an aspherical surface.

Since at least one surface of the lens in the second lens group has an aspherical surface, spherical aberration, astigmatism, chromatic aberration, and so on can be further corrected using a smaller number of lenses. In addition, high image quality can be attained.

In the zoom lens according to the embodiment of the present embodiment, the second lens group may be designed to be shifted substantially in the direction perpendicular to the optical axis to shift an image.

The second lens group can be shifted substantially in the direction perpendicular to the optical axis to shift an image. Therefore, since the second lens group is lightweight and the lens diameter thereof is small, a drive mechanism for vibration control can be minimized.

Instead of changing a diameter of an aperture for adjustment of light quantity, the use of a neutral density (ND) filter or a liquid crystal dimming device is preferable for size reduction and preventing small aperture diffraction from being deteriorated.

Furthermore electric image processing is performed for reducing the diameter of the lens in the first lens group to attain a further size reduction of the zoom lens.

### EMBODIMENTS

Referring now to the drawings and tables, the zoom lens according to each of concrete embodiments of the present invention and numerical examples thereof to which concrete numeral values are applied will be described.

Meanings of signs represented in the descriptions and tables below are as follows:

“si” represents the “i”-th surface from the object side; “ri” represents the curvature radius of the “i”-th surface; “di” represents the distance between the “i”-th surface and the surface of the first surface on the axis; “ni” represents the refractive index of the material of a lens having the “i”-th surface at the d-line (587.6 nm in wavelength); and “νi” represents the Abbe number of the material of a lens having the “i”-th surface at the d-line.

With respect to “si”, “ASP” represents that the corresponding surface is an aspherical surface. With respect to “ri”, “INFINITY” represents that the corresponding surface is a flat surface. With respect to “di”, “variable” represents that the interval concerned is a variable interval.

In addition, “Fno” represents an F number and “ω” represents a half angle of view.

The lens used in each of the numeral examples has an aspherical lens surface.

In the case that the apex of the surface is located on the point of origin, the optical axis direction is the X axis and the height of the lens perpendicular to the optical axis is “h”. Thus, the profile of the aspherical surface can be represented by the following equation:

$$X = \frac{{h}^{2} / R}{1 + \sqrt{1 - ( 1 + K ) {h}^{2} / {R}^{2}}} + Σ {A}_{i} {h}^{i} \qquad [ Equation 1 ]$$

wherein “Ai” represents the coefficient of the “i”-th aspherical surface; “R” represents the curvature radius of the lens; and “K” represents the cone constant of the lens.

Each of zoom lenses 1, 2, and 3, which are examples of the lenses according to the first, second, and third embodiments, includes a first lens group GR1 in which each lens has negative refractive power; a second lens group GR2 in which each lens has positive refractive power; and a third lens group GR3 in which each lens has positive refractive power, which are arranged in this order from an object side to an image side.

In addition, the zoom lenses 1, 2, and 3, when a positional lens state is changed from a wide angle end state to a telephoto end state, the second lens group GR2 moves toward an object in an optical axis direction and both the first lens group GR1 and the third lens group GR3 move in the optical axis direction to reduce the spacing between the first lens group GR1 and the second lens group GR2 and to increase the spacing between the second lens group GR2 and the third lens group GR3.

In each of the zoom lenses 1, 2, and 3, furthermore, a focusing function performed by movement of the third lens group is performed by the movement of the third lens group GR3 in the optical axis direction at the time of changing the object position.

### First Embodiment

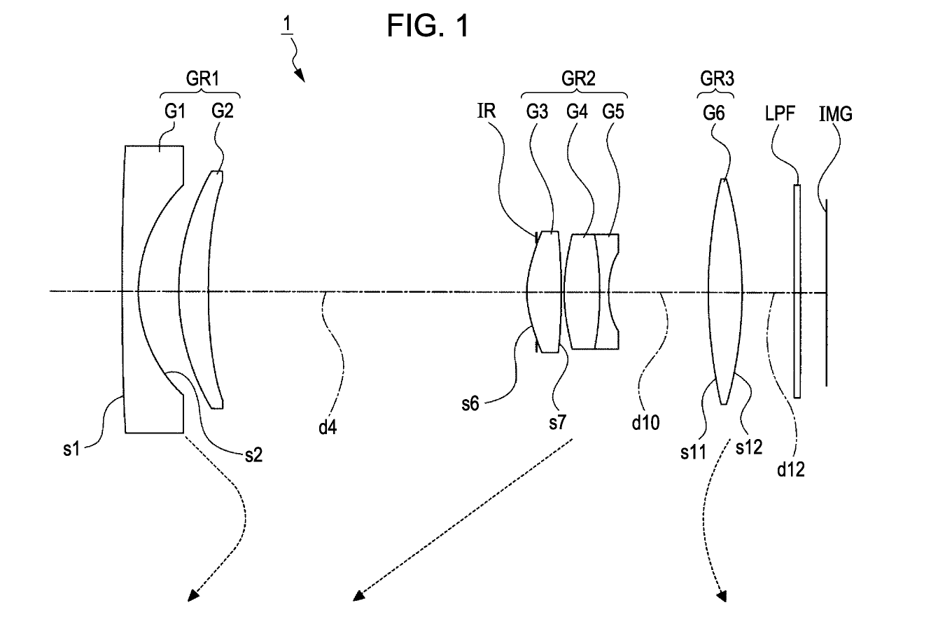

FIG. 1 is a diagram illustrating a lens arrangement of a zoom lens 1 according to the first embodiment of the present invention. The zoom lens 1 includes six lenses.

The first lens group GR1 includes a negative lens G1, where both surfaces are formed as aspheric surfaces, and a positive lens G2 which are arranged in this order from an object side to an image side.

The second lens group GR2 includes a positive lens G3, where both surfaces are formed as aspheric surfaces, a positive lens G4, a negative lens G5. These lenses G3, G4, and G5 are combined together to form a cemented lens while being arranged in this order from the object side to the image side. The second lens group GR2 is movable in the direction almost perpendicular to the optical axis. Thus, the movement of the second lens group GR2 in the direction almost perpendicular to the optical axis allows an image to be shifted.

The third lens group GR3 includes a positive lens, where both surfaces are formed as aspheric surfaces. On the object side of the second lens group GR2, an aperture stop IR (aperture surface s5) is arranged near the second lens group GR2. During the zooming, the aperture stop IR is moved in the optical axis direction while being combined with the second lens group GR2.

A low pass filter LPF is arranged between the third lens group GR3 and the image plane IMG.

Table 1 represents lens data of numerical example 1 obtained by concretely applying numerical values to the zoom lens 1 of the first embodiment.

TABLE 1

| si | ri | di | ni | vi |
|---|---|---|---|---|
| 1 (ASP) | 95.9106 | 0.800 | 1.85135 | 40.1 |
| 2 (ASP) | 5.9455 | 1.750 | | |
| 3 | 9.5790 | 1.400 | 1.92286 | 20.9 |
| 4 | 19.2682 | Variable | | |
| 5 | INFINITY | −0.350 | | |
| (Aperture stop) | | | | |
| 6 (ASP) | 5.5086 | 1.600 | 1.69350 | 53.2 |
| 7 (ASP) | −24.1779 | 0.100 | | |
| 8 | 8.4638 | 1.500 | 1.83481 | 42.7 |
| 9 | −15.1629 | 0.430 | 1.74077 | 27.8 |
| 10 | 3.3558 | Variable | | |
| 11 (ASP) | 25.2096 | 1.550 | 1.52470 | 56.2 |
| 12 (ASP) | −13.4092 | Variable | | |
| 13 | INFINITY | 0.300 | 1.51680 | 64.2 |
| 14 | INFINITY | | | |

In the zoom lens 1, the object-side surface of the negative lens G1 of the first lens group GR1(s1), the image-side surface of the negative lens G1 of the first lens group GR1(s2), the object-side surface of the positive lens G3 of the second lens group GR2(s6), the image-side surface of the positive lens G3 of the second lens group GR2(s7), the object-side surface of the positive lens G6 of the third lens group GR3 (s11), and the image-side surface of the positive lens G6 of the third lens group GR3 (s12) are formed as aspherical surfaces, respectively.

Furthermore, Table 2 represents conical coefficients K as well as the fourth, sixth, eighth, and tenth aspherical surface coefficients A4, A6, A8, and A10 of the aspheric surfaces in numeral example 1.

Furthermore, in each of Table 2 and other tables that represent the aspheric surface coefficients as described later, “E-i” represents an exponential function with the base 10. In other words, it represents “10-i”, for example “0.12345E-05” represents “0.12345×10-5”.

TABLE 2

| si | K | A4 | A6 | A8 | A10 |
|---|---|---|---|---|---|
| 1 | 0 | −6.42289E−04 | 3.39503E−05 | −7.19731E−07 | 5.95570E−09 |
| 2 | 0 | −1.04324E−03 | 2.87452E−05 | −1.44284E−07 | −1.79880E−08 |
| 6 | 0 | −8.49760E−04 | 1.95967E−05 | −9.93054E−06 | 7.25102E−07 |
| 7 | 0 | 1.65345E−04 | 5.00454E−05 | −1.67177E−05 | 1.48923E−06 |
| 11 | 0 | 8.80734E−04 | −1.36593E−04 | 9.01929E−06 | −1.97908E−07 |
| 12 | 0 | 1.72259E−03 | −2.13523E−04 | 1.28850E−05 | −2.70775E−07 |

In the zoom lens 1, during the zooming between a wide angle end state and a telephoto end state, the surface distance d4 between the first lens group GR1 and the aperture stop IR, the surface distance d10 between the second lens group GR2 and the third lens group GR3, and the surface distance d12 between the third lens group GR3 and the low pass filter LPF are changed. Table 3 represents the F number Fno and the half angle of view ω as well as variable distances in a wide angle end state (focal length=5.15), a middle focal position state (focal length=10.01), and a telephoto end state (focal length=19.49) in numeral example 1.

TABLE 3

| | Wide-angle end | Middle focal position | Telephoto end |
|---|---|---|---|
| Focal distance | 5.15 | 10.01 | 19.49 |
| Fno | 2.78 | 3.87 | 5.98 |
| ω (Degree) | 38.64 | 21.12 | 11.10 |
| d4 | 14.664 | 5.721 | 1.050 |
| d10 | 4.552 | 9.248 | 18.056 |
| d12 | 2.303 | 2.175 | 2.072 |

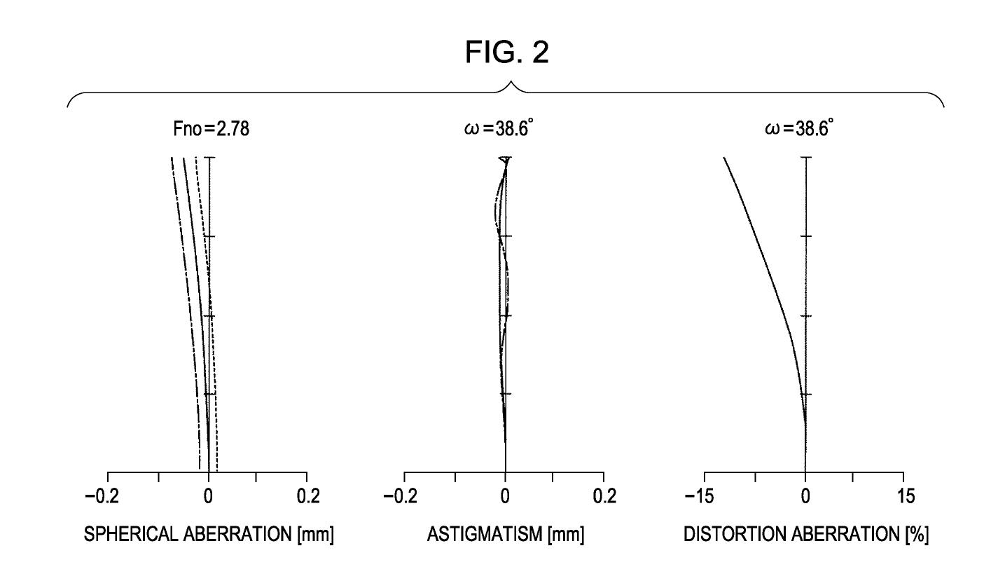

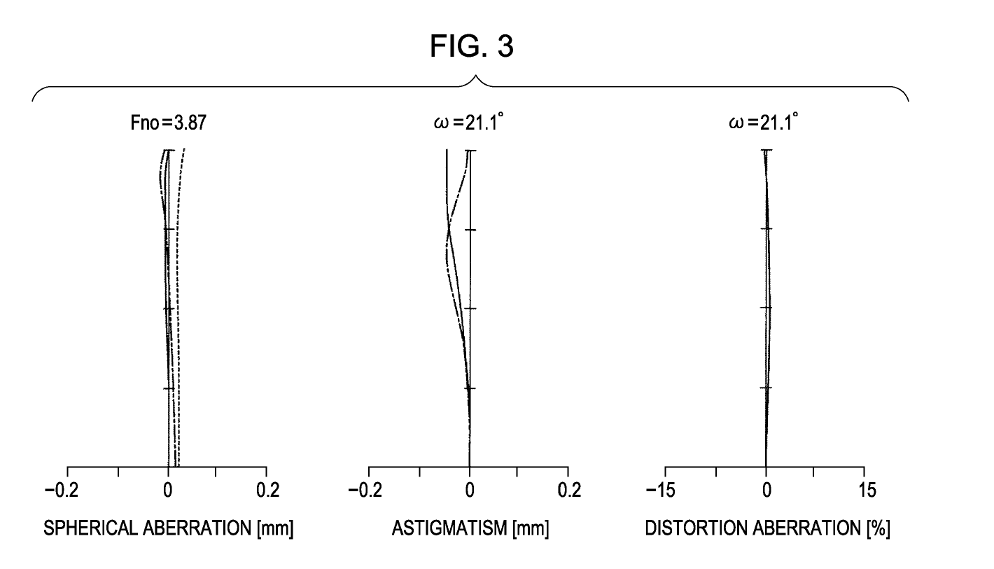

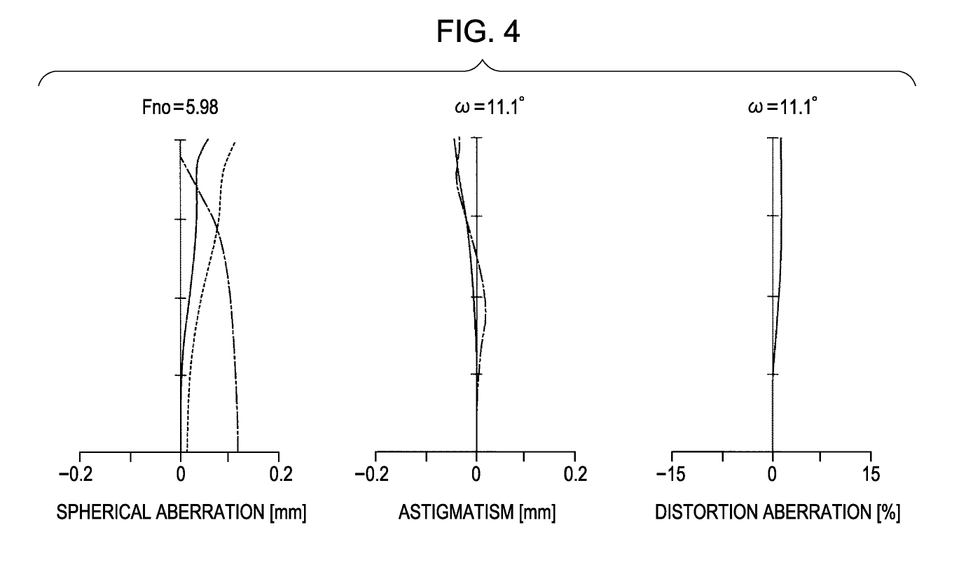

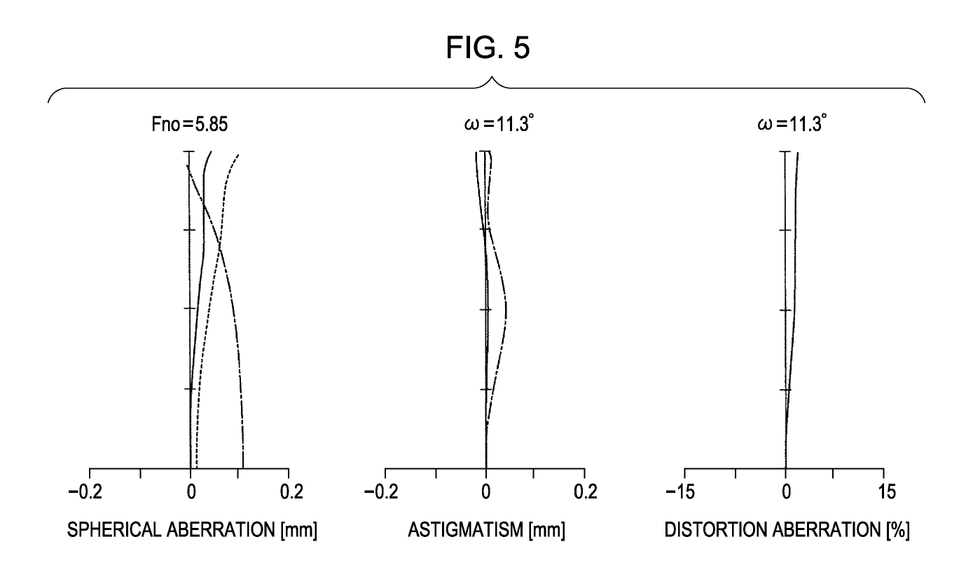

FIGS. 2 to 5 are graphs that represent several aberrations in numeral example 1, respectively. In other words, FIG. 2 illustrates several aberrations during the infinite distance focusing in a wide angle end state (focal length=5.15). FIG. 3 illustrates several aberrations during the infinite distance focusing in a middle angle end state (focal length=10.01). FIG. 4 illustrates several aberrations during the infinite distance focusing in a telephoto angle end state (focal length=19.49). FIG. 5 illustrates several aberrations during the focusing with an object distance of 2 m in the telephoto angle end state.

In each of FIG. 2 to FIG. 5, the ordinate of the spherical aberration graph represents a ratio to an open F number and the abscissa thereof indicates a defocus value. In addition, a solid line represents a spherical aberration at d-line (587.6 nm in wavelength). Also, an alternate-long-and-short-dashed line represents a spherical aberration at g-line (435.8 nm in wavelength). Furthermore, a dashed line represents a spherical aberration at C-line (656.3 nm in wavelength). In each of astigmatism graphs, the ordinate indicates an angle of view, the abscissa indicates a defocus value, a solid line represents a sagittal image plane, and a dashed line represents a meridional image plane. In each of distortion graphs, the ordinate indicates an angle of view, and the abscissa indicates a distortion in %.

As is evident from each of the aberration graphs, it is evident that numeral example 1 shows favorably corrected various aberrations and excellent image forming performance.

### Second Embodiment

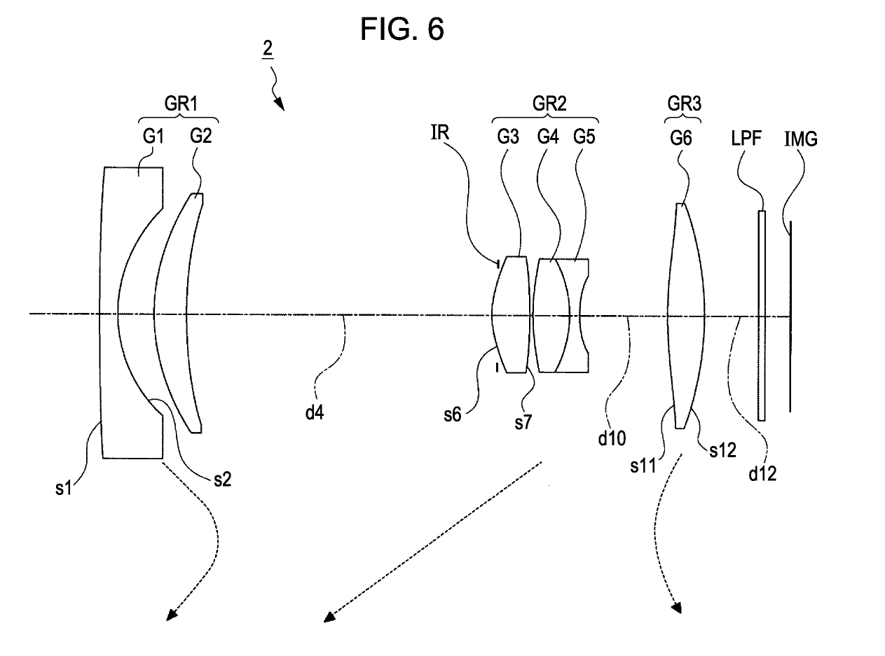

FIG. 6 is a diagram illustrating a lens arrangement of a zoom lens 2 according to the second embodiment of the present invention. The zoom lens 2 includes six lenses.

The first lens group GR1 includes a negative lens G1, where both surfaces are formed as aspheric surfaces, and a positive lens G2. These lenses G1 and G2 are arranged in this order from an object side to an image side.

The second lens group GR2 includes a positive lens G3, where both surfaces are formed as aspheric surfaces, a positive lens G4, a negative lens G5. These lenses G3, G4, and G5 are combined together to form a cemented lens while being arranged in this order from the object side to the image side. The second lens group GR2 is movable in the direction almost perpendicular to the optical axis. Thus, the movement of the second lens group GR2 in the direction almost perpendicular to the optical axis allows an image to be shifted.

The third lens group GR3 includes a positive lens, where both surfaces are formed as aspheric surfaces.

On the object side of the second lens group GR2, an aperture stop IR (aperture surface s5) is arranged near the second lens group GR2. During the zooming, the aperture stop IR is moved in the optical axis direction while being combined with the second lens group GR2.

A low pass filter LPF is arranged between the third lens group GR3 and the image plane IMG.

Table 4 represents lens data of numerical example 2 obtained by concretely applying numerical values to the zoom lens 2 of the second embodiment.

TABLE 4

| si | ri | di | ni | vi |
|---|---|---|---|---|
| 1 (ASP) | 120.0000 | 0.800 | 1.85135 | 40.1 |
| 2 (ASP) | 5.6958 | 1.650 | | |
| 3 | 8.7462 | 1.470 | 1.92286 | 20.9 |
| 4 | 16.8460 | Variable | | |
| 5 | INFINITY | −0.200 | | |
| (Aperture stop) | | | | |
| 6 (ASP) | 6.0415 | 1.600 | 1.69350 | 53.2 |
| 7 (ASP) | −17.1356 | 0.100 | | |
| 8 | 10.3723 | 1.600 | 1.83481 | 42.7 |
| 9 | −5.8161 | 0.430 | 1.69895 | 30.1 |
| 10 | 3.4198 | Variable | | |
| 11 (ASP) | 30.6927 | 1.550 | 1.52470 | 56.2 |
| 12 (ASP) | −12.2195 | Variable | | |
| 13 | INFINITY | 0.300 | 1.51680 | 64.2 |
| 14 | INFINITY | | | |

In the zoom lens 2, the object-side surface of the negative lens G1 of the first lens group GR1(s1), the image-side surface of the negative lens G1 of the first lens group GR1(s2), the object-side surface of the positive lens G3 of the second lens group GR2(s6), the image-side surface of the positive lens G3 of the second lens group GR2(s7), the object-side surface of the positive lens G3 of the third lens group GR3 (s11), and the image-side surface of the positive lens G6 of the third lens group GR3 (s12) are formed as aspherical surfaces, respectively. Table 5 represents conical coefficients K as well as the fourth, sixth, eighth, and tenth aspherical surface coefficients A4, A6, A8, and A10 of the aspheric surfaces in numeral example 2.

TABLE 5

| si | K | A4 | A6 | A8 | A10 |
|---|---|---|---|---|---|
| 1 | 0 | −3.66467E−04 | 2.07015E−05 | −4.79770E−07 | 4.43088E−09 |
| 2 | 0 | −7.56934E−04 | 1.71097E−05 | −2.36442E−07 | −1.78657E−08 |
| 6 | 0 | −1.43565E−03 | −1.97423E−05 | −1.74215E−05 | 6.61035E−07 |
| 7 | 0 | −2.56836E−04 | 4.50758E−06 | −2.46634E−05 | 1.73018E−06 |
| 11 | 0 | 5.78132E−04 | −5.93784E−05 | 2.17382E−06 | −3.59561E−08 |
| 12 | 0 | 1.24265E−03 | −9.70586E−05 | 3.40589E−06 | −5.06125E−08 |

In the zoom lens 2, during the zooming between a wide angle end state and a telephoto end state, the surface distance d4 between the first lens group GR1 and the second lens group GR2, the surface distance d10 between the second lens group GR2 and the third lens group GR3, and the surface distance d12 between the third lens group GR3 and the low pass filter LPF are changed, respectively. Table 6 represents the F number Fno and the half angle of view ω as well as variable distances in a wide angle end state (focal length=4.79), a middle focal position state (focal length=9.07), and a telephoto end state (focal length=18.11) in numeral example 2.

TABLE 6

| | Wide-angle end | Middle focal position | Telephoto end |
|---|---|---|---|
| Focal distance | 4.79 | 9.07 | 18.11 |
| Fno | 2.78 | 3.76 | 5.90 |
| ω (Degree) | 40.98 | 23.16 | 11.94 |
| d4 | 13.922 | 5.459 | 0.900 |
| d10 | 4.056 | 8.130 | 17.026 |
| d12 | 2.417 | 2.483 | 2.137 |

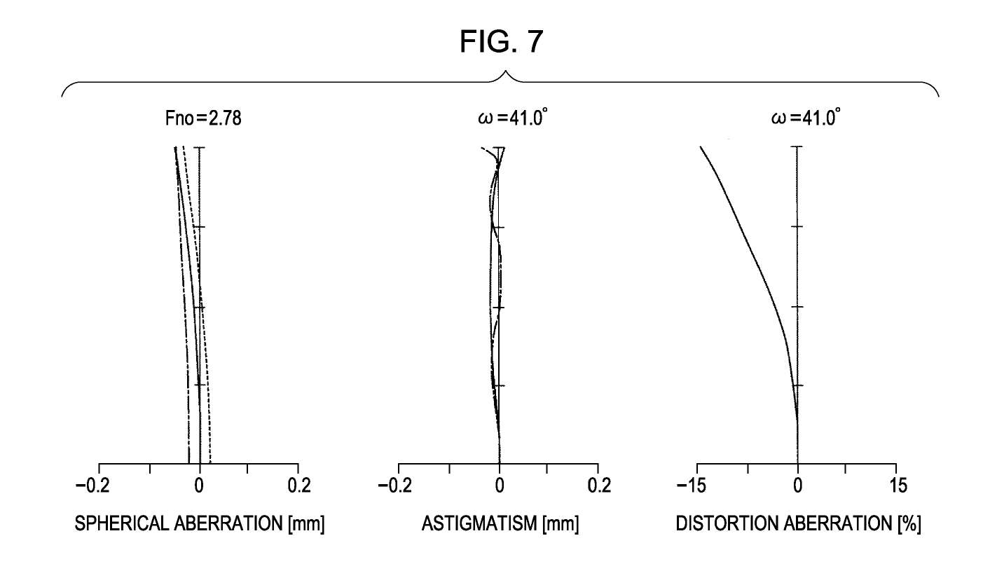

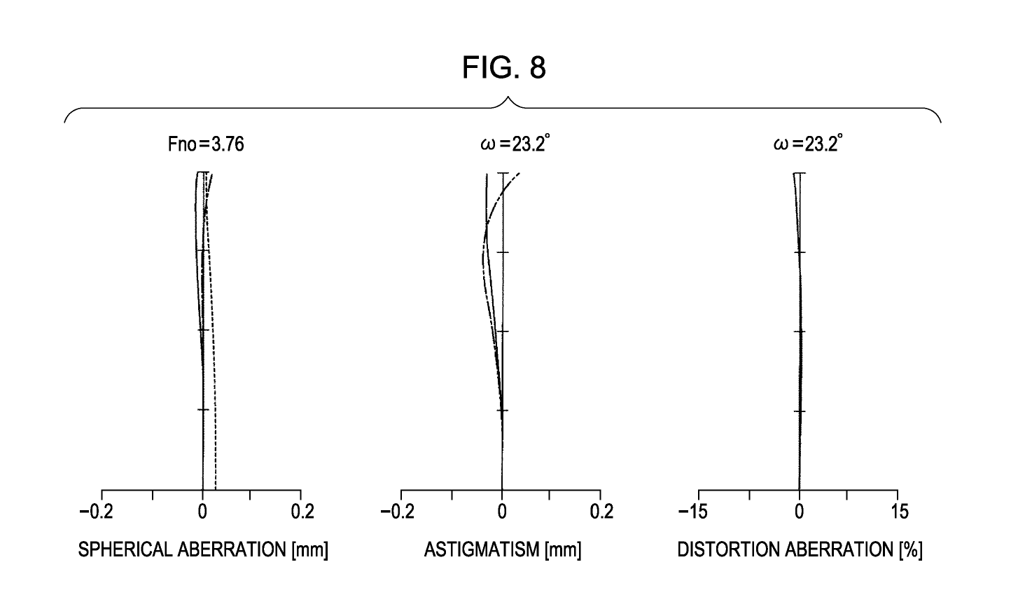

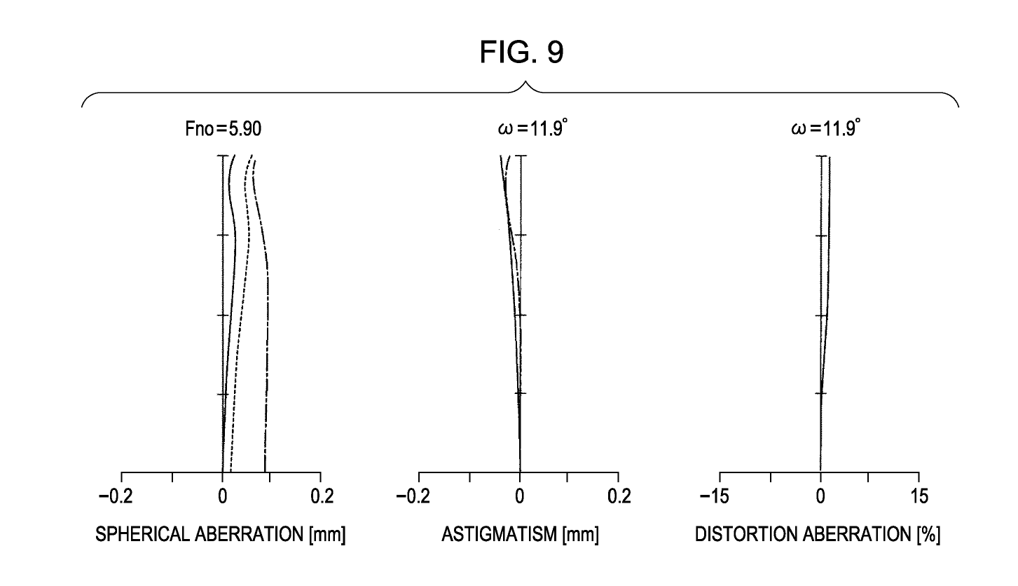

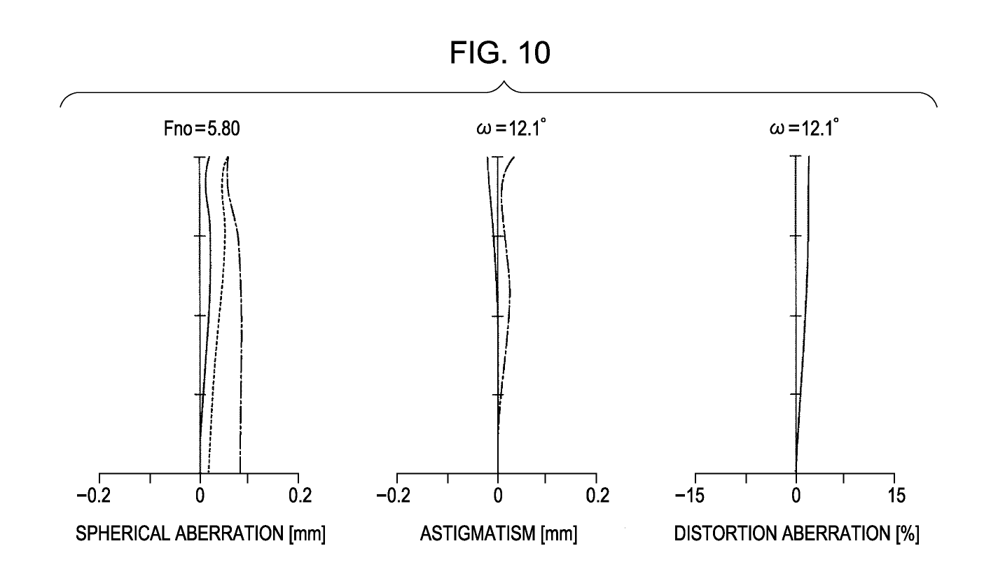

FIGS. 7 to 10 are graphs that represent several aberrations in numeral example 2, respectively. FIG. 7 illustrates several aberrations during the infinite distance focusing in a wide angle end state (focal length=4.79). FIG. 8 illustrates several aberrations during the infinite distance focusing in a middle angle end state (focal length=9.07). FIG. 9 illustrates several aberrations during the infinite distance focusing in a telephoto angle end state (focal length=18.11). Furthermore, FIG. 10 illustrates several aberrations during the focusing with an object distance of 2 m in the telephoto angle end state.

In each of FIG. 7 to FIG. 10, the ordinate of the spherical aberration graph represents a ratio to an open F number and the abscissa thereof indicates a defocus value. In the drawings, a solid line represents a spherical aberration at d-line (587.6 nm in wavelength). Also, an alternate-long-and-short-dashed line represents a spherical aberration at g-line (435.8 nm in wavelength). Furthermore, a dashed line represents a spherical aberration at C-line (656.3 nm in wavelength). In each of astigmatism graphs, the ordinate indicates an angle of view, the abscissa indicates a defocus value, a solid line represents a sagittal image plane, and a dashed line represents a meridional image plane. In each of distortion graphs, the ordinate indicates an angle of view, and the abscissa indicates a distortion in %.

As is evident from each of the aberration graphs, it is evident that numeral example 2 shows favorably corrected various aberrations and excellent image forming performance.

### Third Embodiment

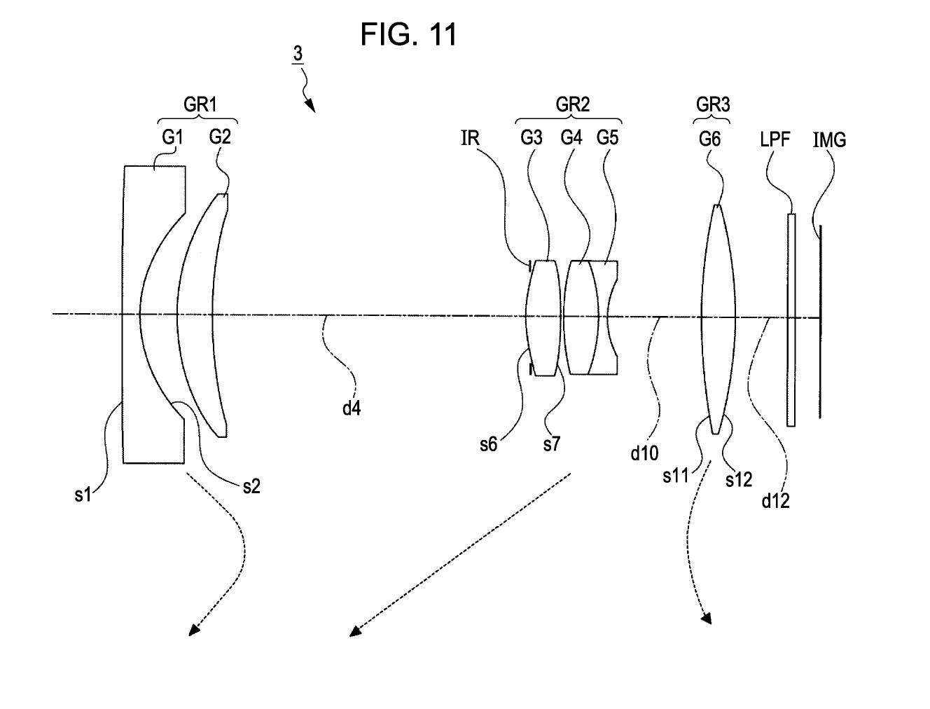

FIG. 11 is a diagram illustrating a lens arrangement of a zoom lens 3 according to the third embodiment of the present invention. The zoom lens 3 includes six lenses.

The first lens group GR1 includes a negative lens G1, where both surfaces are formed as aspheric surfaces, and a positive lens G2. These lenses G1 and G2 are arranged in this order from an object side to an image side.

The second lens group GR2 includes a positive lens G3, where both surfaces are formed as aspheric surfaces, a positive lens G4, a negative lens G5. These lenses G3, G4, and G5 are combined together to form a cemented lens while being arranged in this order from the object side to the image side. The second lens group GR2 is movable in the direction almost perpendicular to the optical axis.

Thus, the movement of the second lens group GR2 in the direction almost perpendicular to the optical axis allows an image to be shifted. The third lens group GR3 includes a positive lens G6, where both surfaces are formed as aspheric surfaces.

On the object side of the second lens group GR2, an aperture stop IR (aperture surface s5) is arranged near the second lens group GR2. During the zooming, the aperture stop IR is moved in the optical axis direction while being combined with the second lens group GR2.

A low pass filter LPF is arranged between the third lens group GR3 and the image plane IMG.

Table 7 represents lens data of numerical example 3 obtained by concretely applying numerical values to the zoom lens 3 of the third embodiment.

TABLE 7

| si | ri | di | ni | vi |
|---|---|---|---|---|
| 1 (ASP) | 150.0000 | 0.800 | 1.85135 | 40.1 |
| 2 (ASP) | 5.6871 | 1.623 | | |
| 3 | 8.6931 | 1.500 | 1.92286 | 20.9 |
| 4 | 16.8575 | Variable | | |
| 5 | INFINITY | −0.200 | | |
| (Aperture stop) | | | | |
| 6 (ASP) | 6.1626 | 1.600 | 1.69350 | 53.2 |
| 7(ASP) | −16.2346 | 0.100 | | |
| 8 | 10.2632 | 1.600 | 1.83481 | 42.7 |
| 9 | −5.8000 | 0.430 | 1.69895 | 30.1 |
| 10 | 3.4362 | Variable | | |
| 11 (ASP) | 26.6453 | 1.550 | 1.52470 | 56.2 |
| 12 (ASP) | −13.0106 | Variable | | |
| 13 | INFINITY | 0.300 | 1.51680 | 64.2 |
| 14 | INFINITY | | | |

In the zoom lens 3, the object-side surface of the negative lens G1 of the first lens group GR1(s1), the image-side surface of the negative lens G1 of the first lens group GR1(s2), the object-side surface of the positive lens G3 of the second lens group GR2(s6), the image-side surface of the positive lens G3 of the second lens group GR2(s7), the object-side surface of the positive lens G6 of the third lens group GR3 (s11), and the image-side surface of the positive lens G6 of the third lens group GR3 (s12) are formed as aspherical surfaces, respectively. Table 8 represents conical coefficients K as well as the fourth, sixth, eighth, and tenth aspherical surface coefficients A4, A6, A8, and A10 of the aspheric surfaces in numeral example 3.

TABLE 8

| si | K | A4 | A6 | A8 | A10 |
|---|---|---|---|---|---|
| 1 | 0 | −3.57005E−04 | 2.02377E−05 | −4.77160E−07 | 4.44181E−09 |
| 2 | 0 | −7.53123E−04 | 1.84378E−05 | −3.21116E−07 | −1.72326E−08 |
| 6 | 0 | −1.49170E−03 | −4.43785E−05 | −1.41092E−05 | 3.11886E−07 |
| 7 | 0 | −3.34178E−04 | −1.64374E−05 | −2.21275E−05 | 1.49390E−06 |
| 11 | 0 | 8.74658E−04 | −5.83310E−05 | 2.58879E−06 | −6.14856E−08 |
| 12 | 0 | 1.57240E−03 | −9.45672E−05 | 3.58391E−06 | −7.34202E−08 |

In the zoom lens 3, during the zooming between a wide angle end state and a telephoto end state, the surface distance d4 between the first lens group GR1 and the second lens group GR2, the surface distance d10 between the second lens group GR2 and the third lens group GR3, and the surface distance d12 between the third lens group GR3 and the low pass filter LPF are changed. Table 9 represents the F number Fno and the half angle of view ω as well as variable distances in a wide angle end state (focal length=4.69), a middle focal position state (focal length=8.78), and a telephoto end state (focal length=17.72) in numeral example 3.

TABLE 9

| | Wide-angle end | Middle focal position | Telephoto end |
|---|---|---|---|
| Focal distance | 4.69 | 8.78 | 17.72 |
| Fno | 2.79 | 3.71 | 5.87 |
| ω (Degree) | 41.81 | 23.83 | 12.22 |
| d4 | 14.013 | 5.447 | 0.900 |
| d10 | 4.052 | 7.707 | 16.662 |
| d12 | 2.302 | 2.571 | 2.088 |

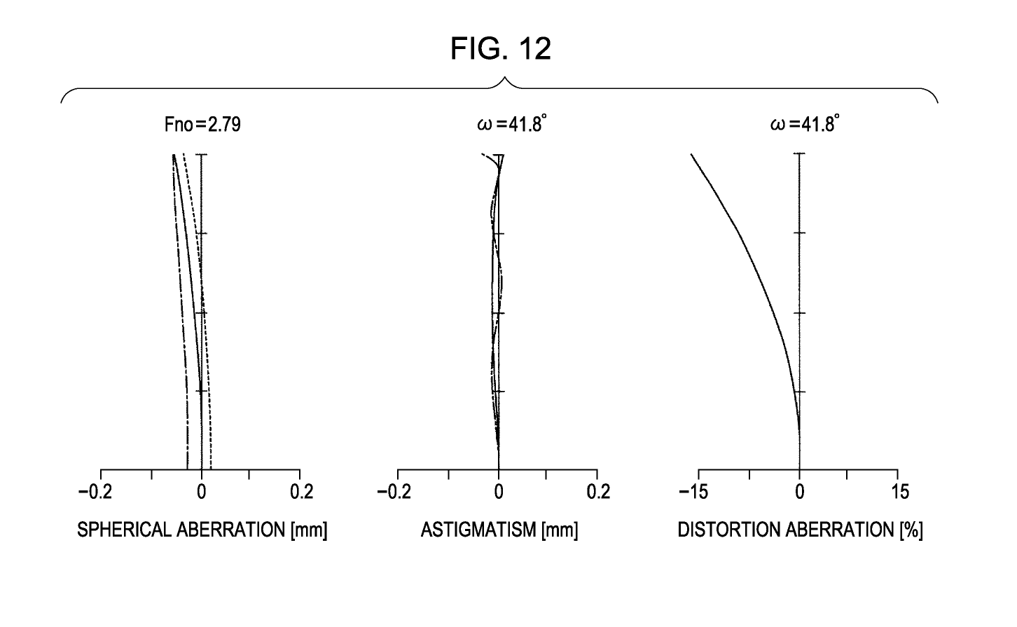

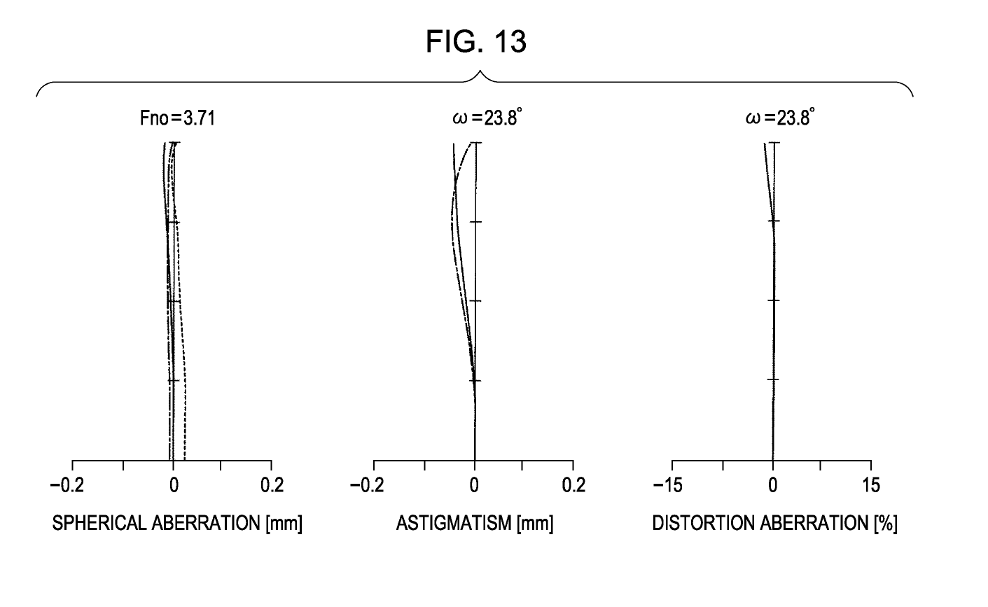

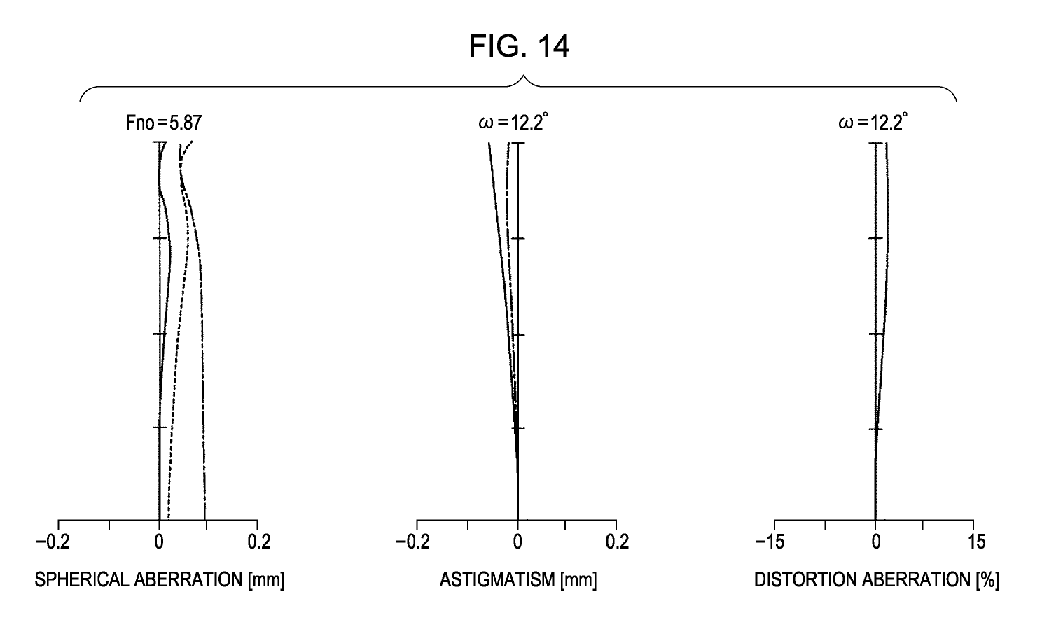

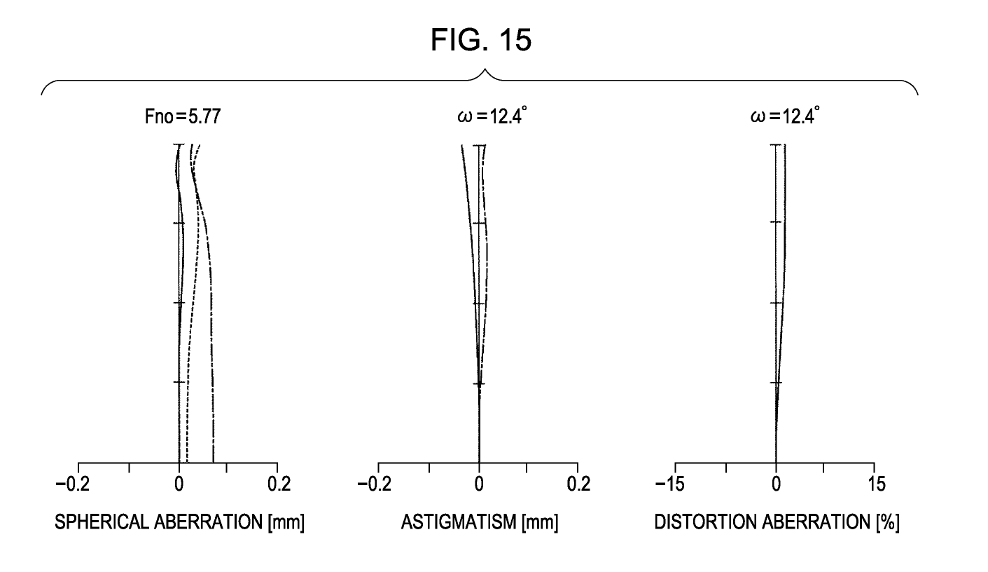

FIGS. 12 to 15 are graphs that represent several aberrations in numeral example 3, respectively. In other words, FIG. 12 illustrates several aberrations during the infinite distance focusing in a wide angle end state (focal length=4.69). FIG. 13 illustrates several aberrations during the infinite distance focusing in a middle angle end state (focal length=8.78). FIG. 14 illustrates several aberrations during the infinite distance focusing in a telephoto angle end state (focal length=17.72). FIG. 15 illustrates several aberrations during the focusing with an object distance of 2 m in the telephoto angle end state.

In each of FIG. 12 to FIG. 15, the ordinate of the spherical aberration graph represents a ratio to an open F number and the abscissa thereof indicates a defocus value. In addition, a solid line represents a spherical aberration at d-line (587.6 nm in wavelength), an alternate-long-and-short-dashed line represents a spherical aberration at g-line (435.8 nm in wavelength), and a dashed line represents a spherical aberration at C-line (656.3 nm in wavelength). In each of astigmatism graphs, the ordinate indicates an angle of view, the abscissa indicates a defocus value, a solid line represents a sagittal image plane, and a dashed line represents a meridional image plane. In each of distortion graphs, the ordinate indicates an angle of view, and the abscissa indicates a distortion in %.

As is evident from each of the aberration graphs, it is evident that numeral example 3 shows favorably corrected various aberrations and excellent image forming performance.

### Fourth Embodiment

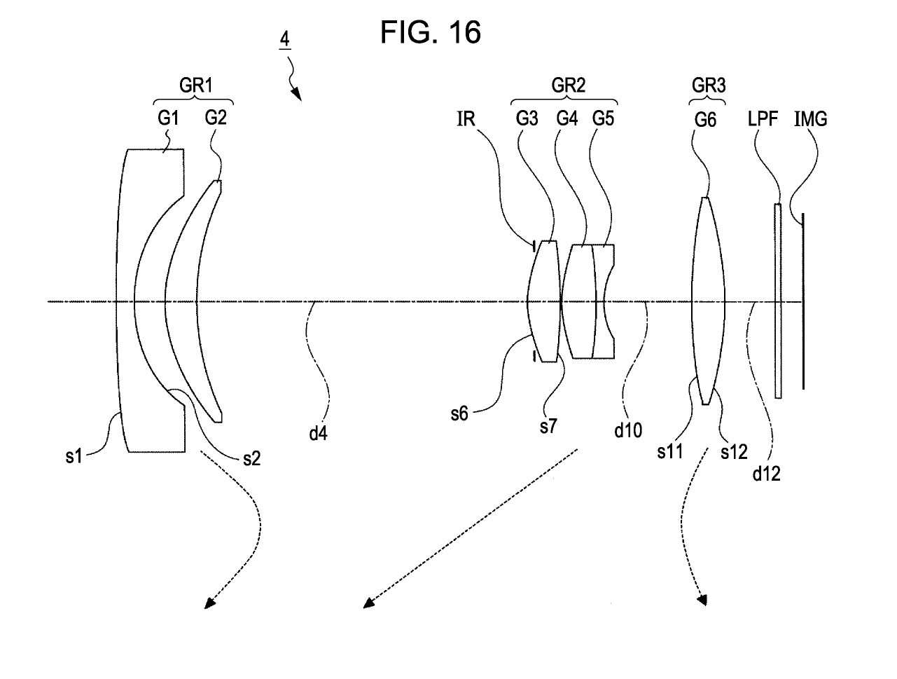

FIG. 16 is a diagram illustrating a lens arrangement of a zoom lens 4 according to the fourth embodiment of the present invention. The zoom lens 4 includes six lenses.

The first lens group GR1 includes a negative lens G1, where both surfaces are formed as aspheric surfaces, and a positive lens G2. These lenses G1 and G2 are arranged in this order from an object side to an image side.

The second lens group GR2 includes a positive lens G3, where both surfaces are formed as aspheric surfaces, a positive lens G4, a negative lens G5. These lenses G3, G4, and G5 are combined together to form a cemented lens while being arranged in this order from the object side to the image side. The second lens group GR2 is movable in the direction almost perpendicular to the optical axis.

Thus, the movement of the second lens group GR2 in the direction almost perpendicular to the optical axis allows an image to be shifted.

The third lens group GR3 includes a positive lens G6, where both surfaces are formed as aspheric surfaces.

On the object side of the second lens group GR2, an aperture stop IR (aperture surface s5) is arranged near the second lens group GR2. During the zooming, the aperture stop IR is moved in the optical axis direction while being combined with the second lens group GR2.

A low pass filter LPF is arranged between the third lens group GR3 and the image plane IMG.

Table 10 represents lens data of numerical example 4 obtained by concretely applying numerical values to the zoom lens 4 of the first embodiment.

TABLE 10

| si | ri | di | ni | vi |
|---|---|---|---|---|
| 1 (ASP) | 63.1468 | 0.800 | 1.85135 | 40.1 |
| 2 (ASP) | 6.1603 | 1.650 | | |
| 3 | 8.2440 | 1.454 | 2.00272 | 19.3 |
| 4 | 12.1514 | Variable | | |
| 5 | INFINITY | −0.300 | | |
| (Aperture stop) | | | | |
| 6 (ASP) | 5.9272 | 1.603 | 1.61881 | 63.9 |
| 7 (ASP) | −24.8103 | 0.100 | | |
| 8 | 6.9641 | 1.572 | 1.81600 | 46.6 |
| 9 | −21.9947 | 0.430 | 1.69895 | 30.1 |
| 10 | 3.3847 | Variable | | |
| 11 (ASP) | 31.6059 | 1.550 | 1.52470 | 56.2 |
| 12 (ASP) | −12.5205 | Variable | | |
| 13 | INFINITY | 0.300 | 1.51680 | 64.2 |
| 14 | INFINITY | | | |

In the zoom lens 4, the object-side surface of the negative lens G1 of the first lens group GR1(s1), the image-side surface of the negative lens G1 of the first lens group GR1(s2), the object-side surface of the positive lens G3 of the second lens group GR2(s6), the image-side surface of the positive lens G3 of the second lens group GR2(s7), the object-side surface of the positive lens G6 of the third lens group GR3 (s11), and the image-side surface of the positive lens G6 of the third lens group GR3 (s12) are formed as aspherical surfaces, respectively. Table 11 represents conical coefficients K as well as the fourth, sixth, eighth, and tenth aspherical surface coefficients A4, A6, A8, and A10 of the aspheric surfaces in numeral example 4.

TABLE 11

| si | K | A4 | A6 | A8 | A10 |
|---|---|---|---|---|---|
| 1 | 0 | −4.37782E−04 | 2.36282E−05 | −4.31913E−07 | 2.90291E−09 |
| 2 | 0 | −6.13937E−04 | 1.22296E−05 | 6.69552E−07 | −2.44767E−08 |
| 6 | 0 | −6.84006E−04 | 1.52610E−07 | −5.71428E−06 | 3.60069E−07 |
| 7 | 0 | 5.43864E−05 | 3.47835E−05 | −1.09172E−05 | 7.91728E−07 |
| 11 | 0 | 6.04682E−04 | −9.11019E−05 | 7.19654E−06 | −1.77064E−07 |
| 12 | 0 | 1.28794E−03 | −1.47585E−04 | 1.00245E−05 | −2.32364E−07 |

In the zoom lens 4, during the zooming between a wide angle end state and a telephoto end state, the surface distance d4 between the first lens group GR1 and the second lens group GR2, the surface distance d10 between the second lens group GR2 and the third lens group GR3, and the surface distance d12 between the third lens group GR3 and the low pass filter LPF are changed. Table 12 represents the F number Fno and the half angle of view ω as well as variable distances in a wide angle end state (focal length=4.84), a middle focal position state (focal length=10.15), and a telephoto end state (focal length=22.91) in numeral example 4.

TABLE 12

| | Wide-angle end | Middle focal position | Telephoto end |
|---|---|---|---|
| Focal distance | 4.84 | 10.15 | 22.91 |
| Fno | 2.46 | 3.50 | 6.05 |
| ω (Degree) | 41.08 | 20.94 | 9.54 |
| d4 | 16.420 | 6.145 | 0.950 |
| dl0 | 4.351 | 9.456 | 21.568 |
| d12 | 2.414 | 2.381 | 2.196 |

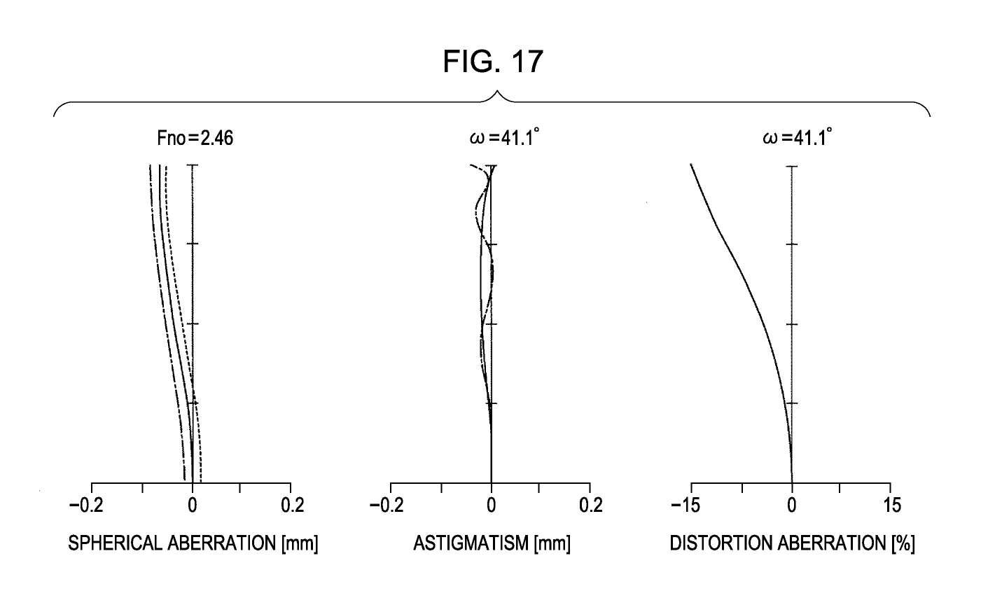

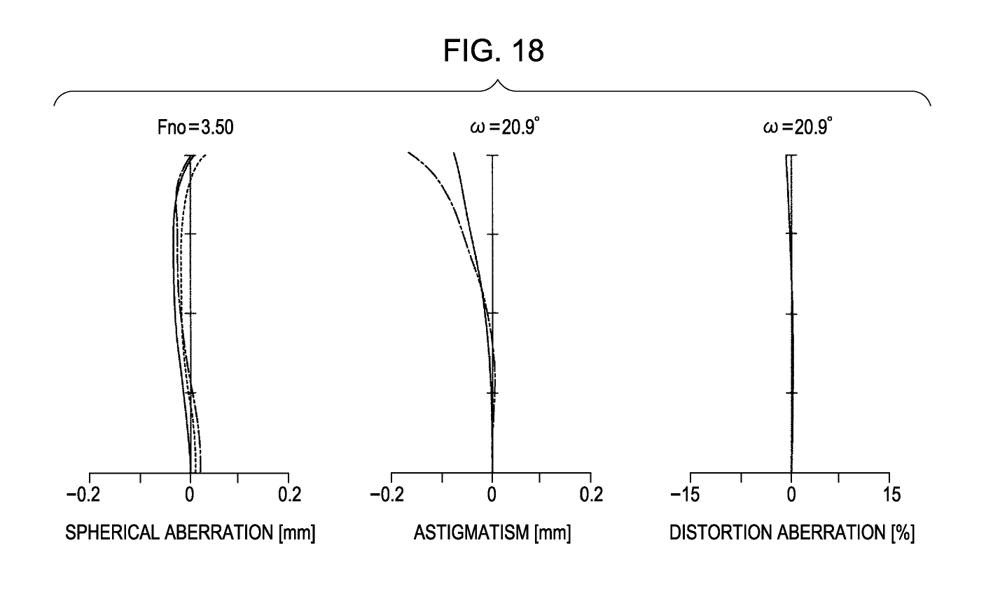

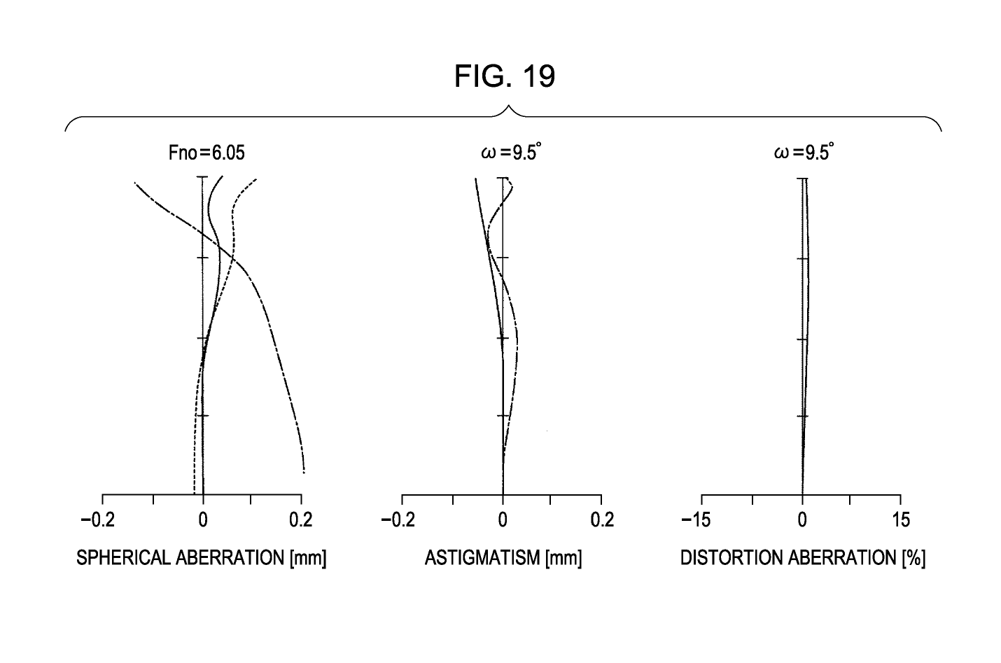

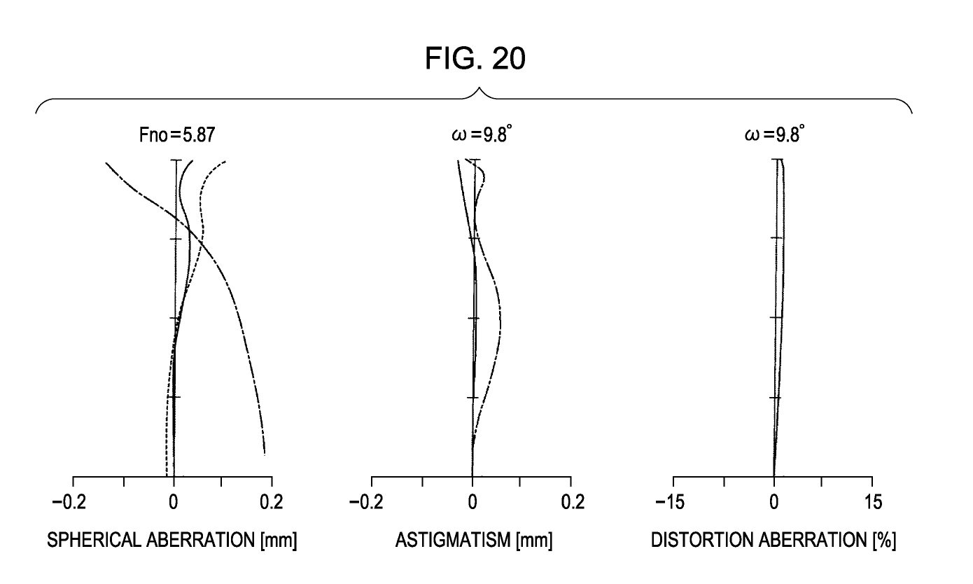

FIGS. 17 to 20 are graphs that represent several aberrations in numeral example 4, respectively. FIG. 17 illustrates several aberrations during the infinite distance focusing in a wide angle end state (focal length=4.84). FIG. 18 illustrates several aberrations during the infinite distance focusing in a middle angle end state (focal length=10.15). FIG. 19 illustrates several aberrations during the infinite distance focusing in a telephoto angle end state (focal length=22.91). FIG. 20 illustrates several aberrations during the focusing with an object distance of 2 m in the telephoto angle end state.

In each of FIG. 17 to FIG. 20, the ordinate of the spherical aberration graph represents a ratio to an open F number and the abscissa thereof indicates a defocus value. In the drawings, a solid line represents a spherical aberration at d-line (587.6 nm in wavelength). Also, an alternate-long-and-short-dashed line represents a spherical aberration at g-line (435.8 nm in wavelength). In addition, a dashed line represents a spherical aberration at C-line (656.3 nm in wavelength). In each of astigmatism graphs, the ordinate indicates an angle of view, the abscissa indicates a defocus value, a solid line represents a sagittal image plane, and a dashed line represents a meridional image plane. In each of distortion graphs, the ordinate indicates an angle of view, and the abscissa indicates a distortion in %.

As is evident from each of the aberration graphs, it is evident that numeral example 4 shows favorably corrected various aberrations and excellent image forming performance.

### Fifth Embodiment

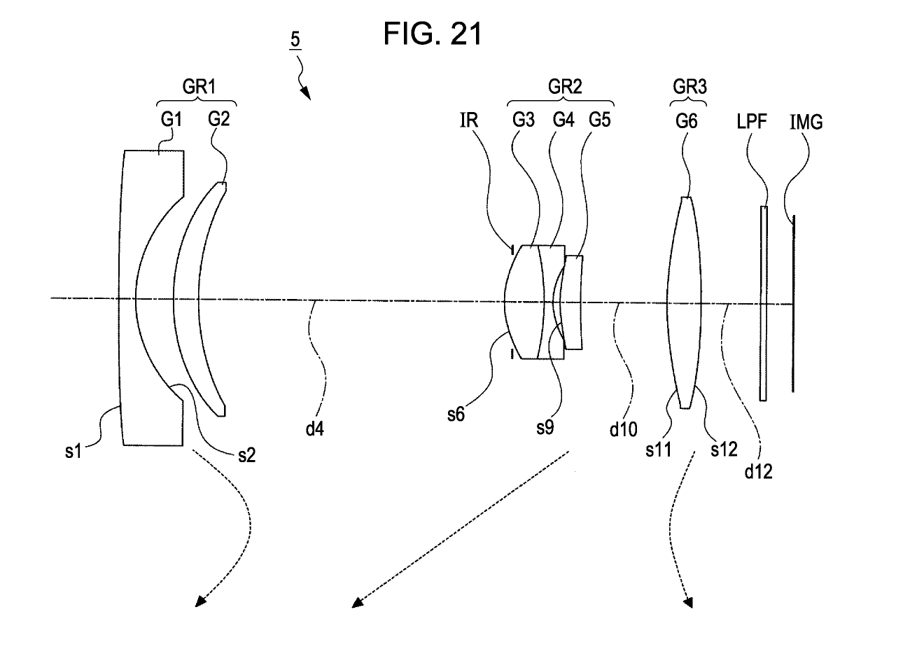

FIG. 21 is a diagram illustrating a lens arrangement of a zoom lens 5 according to the fifth embodiment of the present invention. The zoom lens 5 includes six lenses.

The first lens group GR1 includes a negative lens G1, where both surfaces are formed as aspheric surfaces, and a positive lens G2. These lenses G1 and G2 are arranged in this order from an object side to an image side.

The second lens group GR2 includes: a cemented lens as a combination of a positive lens G3 with one surface provided as an aspheric surfaces and a negative lens G4; and a positive lens G5 with one surface provided as an aspherical surface. These lenses G3, G4, and G5 are arranged in this order from an object side to an image side. The second lens group GR2 is movable in the direction almost perpendicular to the optical axis. Thus, the movement of the second lens group GR2 in the direction almost perpendicular to the optical axis allows an image to be shifted.

The third lens group GR3 includes a positive lens G6, where both surfaces are formed as aspheric surfaces.

On the object side of the second lens group GR2, an aperture stop IR (aperture surface s5) is arranged near the second lens group GR2. During the zooming, the aperture stop IR is moved in the optical axis direction while being combined with the second lens group GR2.

A low pass filter LPF is arranged between the third lens group GR3 and the image plane IMG.

Table 13 represents lens data of numerical example 5 obtained by concretely applying numerical values to the zoom lens 5 of the first embodiment.

TABLE 13

| si | ri | di | ni | vi |
|---|---|---|---|---|
| 1 (ASP) | 60.6971 | 0.900 | 1.80139 | 45.5 |
| 2 (ASP) | 5.8172 | 1.800 | | |
| 3 | 8.1338 | 1.307 | 2.00272 | 19.3 |
| 4 | 11.3466 | Variable | | |
| 5 | INFINITY | −0.400 | | |
| (Aperture stop) | | | | |
| 6 (ASP) | 4.3964 | 1.989 | 1.85135 | 40.1 |
| 7 | −11.2657 | 0.430 | 1.76182 | 26.6 |
| 8 | 3.7371 | 0.301 | | |
| 9 (ASP) | 8.4037 | 1.040 | 1.74330 | 49.3 |
| 10 | 62.7439 | Variable | | |
| 11 (ASP) | 22.6066 | 1.600 | 1.52470 | 56.2 |
| 12 (ASP) | −21.0726 | Variable | | |
| 13 | INFINITY | 0.300 | 1.51680 | 64.2 |
| 14 | INFINITY | | | |

In the zoom lens 5, the object-side surface of the negative lens G1 of the first lens group GR1(s1), the image-side surface of the negative lens G1 of the first lens group GR1(s2), the object-side surface of the positive lens G3 of the second lens group GR2(s6), the object-side surface of the positive lens G5 of the second lens group GR2(s9), the object-side surface of the positive lens G6 of the third lens group GR3 (s11), and the image-side surface of the positive lens G6 of the third lens group GR3 (s12) are formed as aspherical surfaces, respectively. Table 14 represents conical coefficients K as well as the fourth, sixth, eighth, and tenth aspherical surface coefficients A4, A6, A8, and A10 of the aspheric surfaces in numeral example 5.

TABLE 14

| si | K | A4 | A6 | A8 | A10 |
|---|---|---|---|---|---|
| 1 | 0 | −4.82525E−04 | 2.04660E−05 | −3.35864E−07 | 2.05703E−09 |
| 2 | 0 | −4.67416E−04 | 1.69876E−05 | 4.26620E−07 | −1.06193E−08 |
| 6 | −0.5 | 4.90886E−04 | 4.62338E−05 | −5.23914E−06 | 8.21860E−07 |
| 9 | −0.5 | −1.19080E−03 | −2.50295E−04 | 4.69010E−05 | −1.20760E−05 |
| 11 | 0 | 3.53004E−04 | −3.97204E−05 | 1.96026E−06 | −3.77835E−08 |
| 12 | 0 | 8.11090E−04 | −7.32262E−05 | 3.27159E−06 | −5.91468E−08 |

In the zoom lens 5, during the zooming between a wide angle end state and a telephoto end state, the surface distance d4 between the first lens group GR1 and the second lens group GR2, the surface distance d10 between the second lens group GR2 and the third lens group GR3, and the surface distance d12 between the third lens group GR3 and the low pass filter LPF are changed. Table 15 represents the F number Fno and the half angle of view ω as well as variable distances in a wide angle end state (focal length=4.84), a middle focal position state (focal length=9.84), and a telephoto end state (focal length=20.59) in numeral example 5.

TABLE 15

| | Wide-angle end | Middle focal position | Telephoto end |
|---|---|---|---|
| Focal distance | 4.84 | 9.84 | 20.59 |
| Fno | 2.66 | 3.67 | 6.02 |
| ω (Degree) | 41.18 | 21.66 | 10.60 |
| d4 | 15.173 | 5.460 | 0.923 |
| d10 | 4.214 | 9.031 | 20.141 |
| d12 | 2.894 | 3.006 | 1.930 |

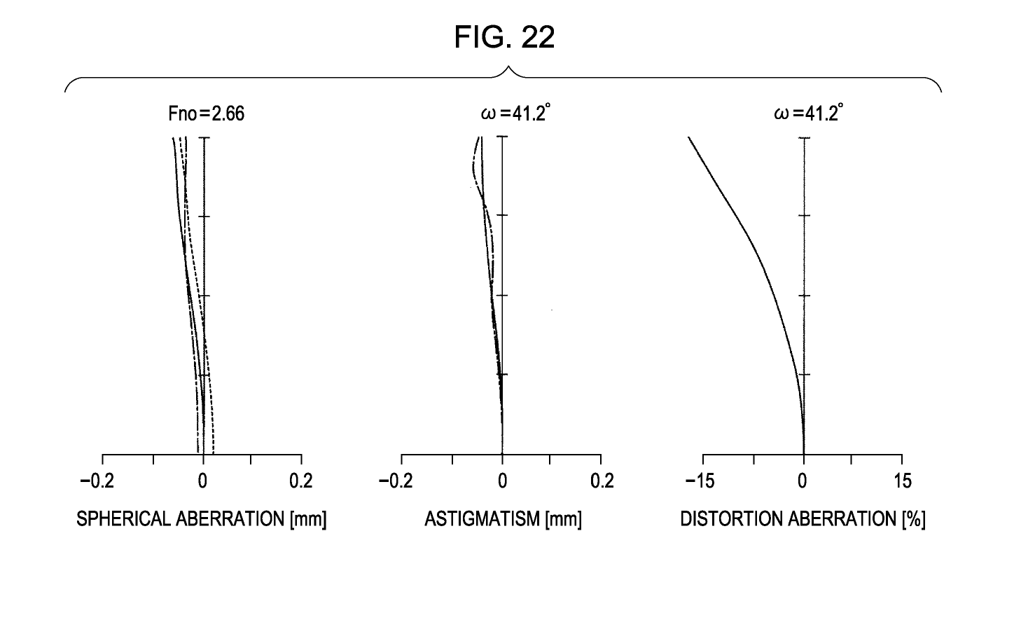

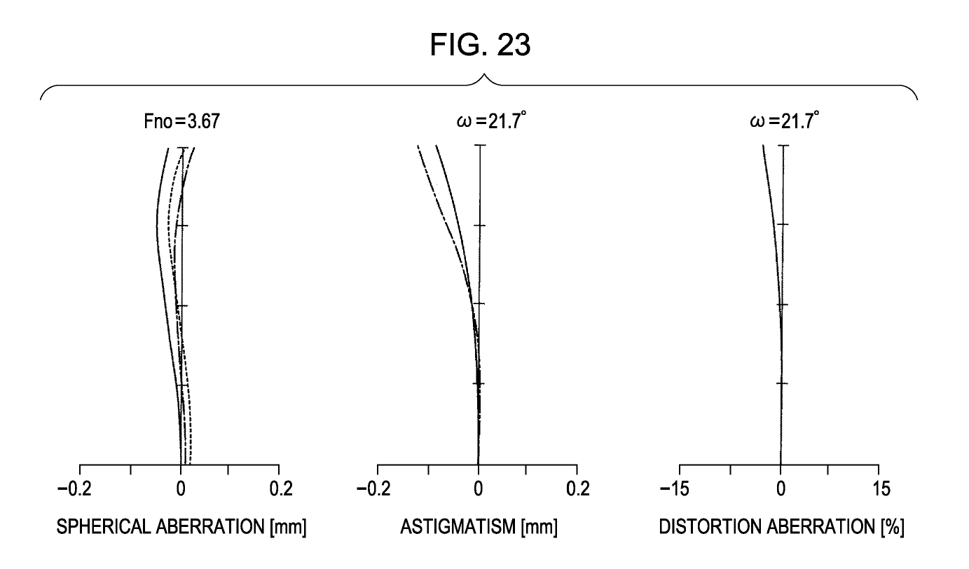

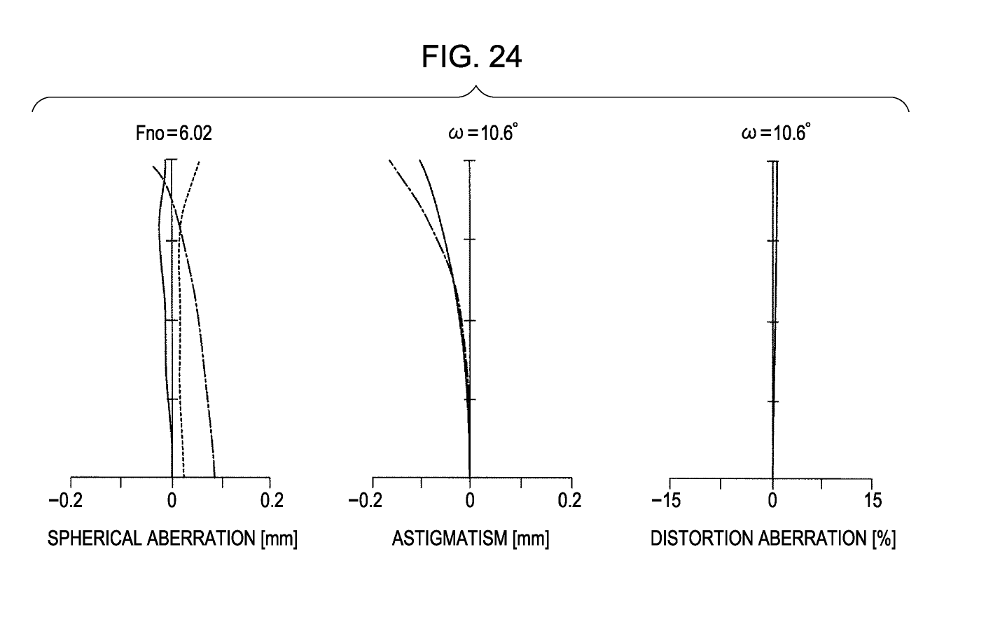

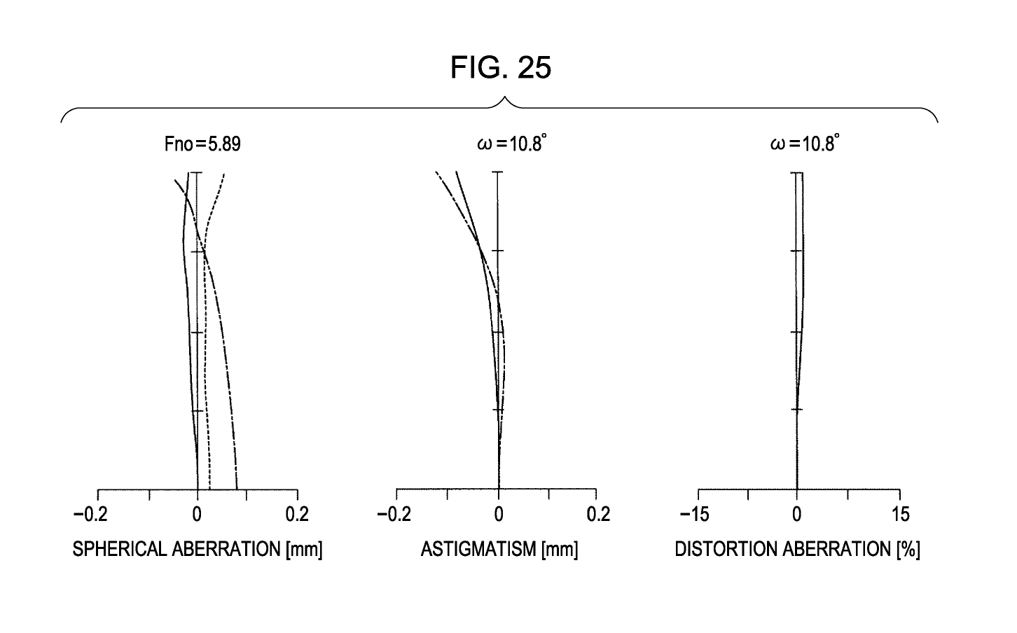

FIGS. 22 to 25 are graphs that represent several aberrations in numeral example 5, respectively. In other words, FIG. 22 illustrates several aberrations during the infinite distance focusing in a wide angle end state (focal length=4.84). FIG. 23 illustrates several aberrations during the infinite distance focusing in a middle angle end state (focal length=9.84). FIG. 24 illustrates several aberrations during the infinite distance focusing in a telephoto angle end state (focal length=20.59). FIG. 25 illustrates several aberrations during the focusing with an object distance of 2 m in the telephoto angle end state.

In each of FIG. 22 to FIG. 25, the ordinate of the spherical aberration graph represents a ratio to an open F number and the abscissa thereof indicates a defocus value. In the drawings, a solid line represents a spherical aberration at d-line (587.6 nm in wavelength). Also, an alternate-long-and-short-dashed line represents a spherical aberration at g-line (435.8 nm in wavelength). In addition, a dashed line represents a spherical aberration at C-line (656.3 nm in wavelength). In each of astigmatism graphs, the ordinate indicates an angle of view, the abscissa indicates a defocus value, a solid line represents a sagittal image plane, and a dashed line represents a meridional image plane. In each of distortion graphs, the ordinate indicates an angle of view, and the abscissa indicates a distortion in %.

As is evident from each of the aberration graphs, it is evident that numeral example 5 shows favorably corrected various aberrations and excellent image forming performance.

### [Conclusions of Conditional Expressions]

Table 16 shows each of values used in the above conditional expressions (1) to (4) with respect to the zoom lenses 1, 2, 3, 4, and 5, respectively.

In other words, Table 16 represents Da, Dg, Ya, Yb, ZA1−ZRa1, ZA2−ZRa2, Ca1, Ca2, N, f1, ZAb1−ZRb1, ZAb1−ZRb2, Cb1, Cb2, Nb, f3, AsPa1, AsPa2, ASPb1, an ASPb2 of the conditional expressions (1) to (4).

TABLE 16

| | | Zoom lens 1 | Zoom lens 2 | Zoom lens 3 | Zoom lens 4 | Zoom lens 5 |
|---|---|---|---|---|---|---|
| | Da | 8.000E−01 | 8.000E−01 | 8.000E−01 | 8.000E−01 | 9.000E−01 |
| | Db | 1.550E+00 | 1.550E+00 | 1.550E+00 | 1.550E+00 | 1.600E+00 |
| | Ya | 3.200E+00 | 3.200E+00 | 3.200E+00 | 3.200E+00 | 3.600E+00 |
| | Yb | 3.100E+00 | 3.100E+00 | 3.100E+00 | 3.100E+00 | 3.200E+00 |
| | ZAa1-ZRa1 | −3.813E−02 | −2.098E−02 | −2.045E−02 | −2.496E−02 | −4.526E−02 |
| | ZAa2-ZRa2 | −0.822E−01 | −0.656E−01 | −0.647E−01 | −0.468E−01 | −0.082E+00 |
| | Ca1 | 1.043E−02 | 8.333E−03 | 6.667E−03 | 1.584E−02 | 1.648E−02 |
| | Ca2 | 1.682E−01 | 1.756E−01 | 1.758E−01 | 1.623E−01 | 1.719E−01 |
| | Na | 1.856E+00 | 1.856E+00 | 1.856E+00 | 1.856E+00 | 1.806E+00 |
| | f1 | −1.338E+01 | −1.250E+01 | −1.235E+01 | −1.320E+01 | −1.255E+01 |
| | ZAb1-ZRb1 | 0.208E−01 | 0.162E−01 | 0.461E−01 | 0.219E−01 | 0.116E−01 |
| | ZAb2-ZRb2 | 0.572E−01 | 0.535E−01 | 0.858E−01 | 0.544E−01 | 0.358E−01 |
| | Cb1 | 3.967E−02 | 3.258E−02 | 3.753E−02 | 3.164E−02 | 4.423E−02 |
| | Cb2 | −7.458E−02 | −8.184E−02 | −7.686E−02 | −7.987E−02 | −4.745E−02 |
| | Nb | 1.527E+00 | 1.527E+00 | 1.527E+00 | 1.527E+00 | 1.527E+00 |
| | f3 | 1.685E+01 | 1.680E+01 | 1.682E+01 | 1.723E+01 | 2.096E+01 |
| Conditional expression (1) | ASPa1 | 0.319 | 0.235 | 0.290 | 0.139 | 0.272 |
| Conditional expression (2) | ASPa2 | −0.043 | −0.035 | −0.035 | −0.025 | −0.047 |
| Conditional expression (3) | ASPb1 | 0.059 | 0.056 | 0.138 | 0.076 | 0.024 |
| Conditional expression (4) | ASPb2 | 0.087 | 0.074 | 0.126 | 0.075 | 0.068 |

As is evident from Table 16, the zoom lenses 1, 2, 3, 4, and 5 are constructed to satisfy the above conditional expressions (1) to (4), respectively.

### [Configuration of Image Pickup Apparatus]

Next, the configuration of an image pickup apparatus according to the embodiment of the present invention will be described.

The image pickup apparatus of the present embodiment includes a zoom lens and an imaging device that converts an optical image formed by the zoom lens into an electrical signal.

In the image pickup apparatus, the zoom lens includes a first lens group having negative refractive power, a second lens group having positive refractive power, and a third lens group having positive refractive power which are arranged in that order from an object side to an image side.

In the image pickup apparatus of the present embodiment, when a positional lens state is changed from a wide angle end state to a telephoto end state, the second lens group moves toward an object in an optical axis direction and both the first lens group and the third lens group move in the optical axis direction to reduce the spacing between the first lens group and the second lens group and to increase the spacing between the second lens group and the third lens group.

In the image pickup apparatus of the present embodiment, furthermore, the zoom lens performs short distance focusing by the movement of the third lens group in the optical axis direction at the time of changing the object position.

In the image pickup apparatus of the present embodiment, furthermore, the zoom lens includes the first lens group that contains a negative lens and a positive lens which are arranged in this order from an image side to an object side.

The third lens group includes a positive lens. Both surfaces of the negative lens of the first lens group are aspherical surfaces, respectively. Both surfaces of the positive lens of the third lens group are aspherical surfaces, respectively.

In the image pickup apparatus of the present invention, as described above, the first lens group of the zoom lens includes a negative lens and a positive lens, where both surfaces of each lens are aspherical surfaces. The third lens group includes a positive lens where both surfaces thereof are aspherical surfaces.

Therefore, the number of lenses in each of the lens groups is set to the minimal number of lenses enough to favorably correct spherical aberration, astigmatism, chromatic aberration, and so on. In the case of thickness reduction, particularly thickness reduction of a retractable lens type image pickup apparatus, it can be performed at the time of housing the optical system.

The zoom lens of the present embodiment is constructed so that it can satisfy the following conditional expressions

0.10<ASPa1<0.36; (1)

−0.05<ASPa2<−0.02; (2)

0<ASPb1<0.20; and (3)

0.04<ASPb2<0.15, wherein (4)

ASPa1=(ZAa1−ZRa1)/{Ca1(Na−1)·f1},

ASPa2=(ZAa2−ZRa2)/{Ca2(1−Na)·f1},

AsPb1=(ZAb1−ZRb1)/{Cb1(Nb−1)·f3},

AsPb2=(ZAb2−ZRb2)/{Cb2(1−Nb)·f3},

Db: thickness of the positive lens on the optical axis of the third lens group,

Ya=4Da,

Yb=2 Db,

ZRa1: coordinate in the optical axis direction at a height corresponding to Ya from the optical axis of an object-side paraxial curvature surface of the negative lens in the first lens group,

ZRa2: coordinate in the optical axis direction at a height corresponding to Ya from the optical axis of an image-side paraxial curvature surface of the negative lens in the first lens group;

ZAa1: coordinate in the optical axis direction at a height corresponding to Ya from the optical axis of an object-side aspherical surface of the negative lens in the first lens group,

ZAa2: coordinate in the optical axis direction at a height corresponding to Ya from the optical axis of an image-side aspherical surface of the negative lens in the first lens group,

Ca1: paraxial curvature of the object-side aspherical surface of the negative lens in the first lens group,

Ca2: paraxial curvature of the image-side aspherical surface of the negative lens in the first lens group,

Na: refractive index to the e-line of the negative lens in the first lens group,

f1: focal length of the first lens group,

ZRb1: coordinate in the optical axis direction at a height corresponding to Yb from the optical axis of an object-side paraxial curvature surface of the positive lens in the third lens group,

ZRb2: coordinate in the optical axis direction at a height corresponding to Yb from the optical axis of an image-side paraxial curvature surface of the positive lens in the third lens group,

ZAb1: coordinate in the optical axis direction at a height corresponding to Yb from the optical axis of an object-side aspherical surface of the positive lens in the third lens group,

ZAb2: coordinate in the optical axis direction at a height corresponding to Yb from the optical axis of an image-side aspherical surface of the positive lens in the third lens group,

Cb1: paraxial curvature of the object-side aspherical surface of the positive lens in the third lens group;

Cb1: paraxial curvature of the image-side aspherical surface of the positive lens in the third lens group;

Nb: refractive index to the e-line of the positive lens in the third lens group, and

f3: focal length of the third lens group.

If the image pickup apparatus satisfies conditional expression (1), then the effect of the aspherical surface can be fairly exerted and good aberration compensation can be performed to improve the optical performance of the zoom lens.

In addition, if the image pickup apparatus satisfies conditional expression (2), then the effect of the aspherical surface can be fairly exerted and good aberration compensation is performed. As a result, an improvement of optical performance and a simplified formation of a negative lens in the first lens group can be attained.

Furthermore, if the image pickup apparatus satisfies conditional expression (3), then the effect of the aspherical surface can be fairly exerted and good aberration compensation can be performed to improve the optical performance of the zoom lens.

Additionally, if the image pickup apparatus satisfies conditional expression (4), then the effect of the aspherical surface can be fairly exerted and good aberration compensation can be performed to improve the optical performance of the zoom lens.

FIG. 16 is a block diagram illustrating the configuration of a digital still camera according to one of the embodiments of the present invention.

An image pickup apparatus (digital still camera) 100 includes a camera block 10 having an image-capturing function. The image pickup apparatus 100 also includes a camera signal processing section 20 that performs signal processing such as analog-to-digital conversion of a captured image signal and an image processing section 30 that performs recording and reproducing processing of the image signal. In addition, the image pickup apparatus 100 includes a liquid crystal display (LCD) 40 that displays a captured image and the like, a reader/writer (R/W) 50 that writes or reads image data on or from a memory card 1000, and a central processing unit (CPU) that controls the entire apparatus. The image pickup apparatus 100 further includes an input section 70 for an input operation by a user, which is constructed of a various kinds of switches and so on, and a lens drive control section that controls driving of lenses provided in the camera block 10.

The camera block 10 includes, for example, an optical system containing a zoom lens 11 (each of the zoom lenses 1, 2, and 3 to which any of the embodiments of the present invention can be applied) to which any embodiment of the present invention is applied, and an imaging device 12 such as a charge coupled device (CCD) or a complementary metal-oxide semiconductor (CMOS).

The camera signal processing section 20 performs various kinds of signal processing including conversion of an output signal from the imaging device 12 into a digital signal, denoising, correction of the image quality, and conversion of a signal into a luminance signal and a color-difference signal.

The image processing section 30 performs compressing and encoding processing, and decompressing and decoding processing for an image signal on the basis of a predetermined image data format; and conversion of a data specification such as a resolution.

The LCD 40 has a function of displaying various kinds of data, such as an operating state of the user to an input section 70.

The R/W 50 writes image data coded by the image processing section 30 on the memory card 1000 and reads the image data recorded on the memory card 1000.

The CPU 60 is functioned a control processing section that controls each of the circuit blocks mounted on the image pickup apparatus 100 and controls each of the circuit blocks based on an instruction input signal and so on from the input section 70.

The input section 70 includes, for example, a shutter release button for a shutter operation, and a mode selection switch for selecting an operation mode. The input section 70 outputs an instruction input signal corresponding to an operation of the user to the CPU 60.

The lens drive control section 80 controls a motor (not shown) or the like for driving lenses provided in the zoom lens 11, on the basis of a control signal from the CPU 60.

The memory card 1000 is, for example, a semiconductor memory which is removably attached to a slot connected to the R/W 50.

### [Operation of Image Pickup Apparatus]

Hereinafter, the operation of the image pickup apparatus 100 will be described.

In a standby state of photographing, under the control of the CPU 60, an image signal captured with the lens block 10 is output to the camera signal processing section 20, and then to the LCD 40, thereby being displayed as a camera-through image. When an instruction input signal for zooming is input from the input section 70, the CPU 60 outputs a control signal to the lens drive control section 80, and a predetermined lens in the zoom lens 11 is moved on the basis of the control of the lens drive control section 80.

When a shutter (not shown) provided in the lens block 10 is released in accordance with an instruction input signal from the input section 70, a captured image signal is output from the camera signal processing section 20 to the image processing section 30. Then, the image signal is subjected to the compressing and encoding processing. Subsequently, the signal is converted into digital data with a predetermined format. The converted data is output to the reader/writer 50, and is written on the memory card 1000.

Focusing can be performed, for example, when the shutter release button of the input section 70 is half pressed, or fully pressed for recording, and accordingly, the lens drive control section 80 allows a predetermined lens in the zoom lens 11 to be moved on the basis of a control signal from the CPU 60.

To reproduce image data stored in the memory card 1000, in accordance with an operation with the input section 70, the reader/writer 50 reads desired image data from the memory card 1000, the image processing section 30 performs the decompressing and decoding processing for the image data, and then a reproduction image signal is output to the LCD 40. Accordingly, a reproduction image is displayed.

In the above-described embodiment, while the image pickup apparatus according to the embodiment of the present invention is applied to a digital still camera, the image pickup apparatus may be not limited to the digital still camera. The image pickup apparatus according to any of the embodiments is widely applicable to cellular phones in which a digital video camera and camera section of a digital input/output apparatus such as a personal digital assistant (PDA).

It should be understood by those skilled in the art that various modifications, combinations, sub-combinations and alterations may occur depending on design requirements and other factors insofar as they are within the scope of the appended claims or the equivalents thereof.

What is claimed is:

1. A zoom lens comprising
a first lens group having negative refractive power,
a second lens group having positive refractive power, and
a third lens group having positive refractive power which are arranged in order from an object side to an image side, wherein
when a positional lens state is changed from a wide angle end state to a telephoto end state, said second lens group moves toward an object in an optical axis direction and both said first lens group and said third lens group move in said optical axis direction to reduce said spacing between said first lens group and said second lens group and to increase the spacing between said second lens group and said third lens group;
a focusing function performed by movement of the third lens group is performed by the movement of said third lens group in the optical axis direction at the time of changing the object position;
said first lens group includes a negative lens and a positive lens which are arranged in this order from an object side to an image side;
said third lens group includes a positive lens;
both surfaces of said negative lens of said first lens group are aspherical surfaces, respectively;
both surfaces of said positive lens of said third lens group are aspherical surfaces, respectively; and
the following conditional expressions (1) to (4) are satisfied:
0.10<ASPa1<0.36; (1)
−0.05<ASPa2<−0.02; (2)
0<ASPb1<0.20; and (3)
0.04<ASPb2<0.15, wherein (4)
ASPa1=(ZAa1−ZRa1)/{Ca1(Na−1)·f1},
ASPa2=(ZAa2−ZRa2)/{Ca2(1−Na)·f1},
AsPb1=(ZAb1−ZRb1)/{Cb1(Nb−1)·f3},
AsPb2=(ZAb2−ZRb2)/{Cb2(1−Nb)·f3},
Da is defined as a thickness of said negative lens on said optical axis of said first lens group,
Db is defined as a thickness of said positive lens on said optical axis of said third lens group,
Ya=4Da,
Yb=2 Db,
ZRa1 is defined as a coordinate in the optical axis direction at a height corresponding to Ya from the optical axis of an object-side paraxial curvature surface of said negative lens in said first lens group,
ZRa2 is defined as a coordinate in the optical axis direction at a height corresponding to Ya from the optical axis of an image-side paraxial curvature surface of said negative lens in said first lens group,
ZAa1 is defined as a coordinate in the optical axis direction at a height corresponding to Ya from the optical axis of an object-side aspherical surface of said negative lens in said first lens group,
ZAa2 is defined as a coordinate in the optical axis direction at a height corresponding to Ya from the optical axis of an image-side aspherical surface of said negative lens in said first lens group,
Ca1 is defined as a paraxial curvature of the object-side aspherical surface of said negative lens in said first lens group,
Ca2 is defined as a paraxial curvature of the image-side aspherical surface of said negative lens in said first lens group,
Na is defined as a refractive index to the e-line of said negative lens in said first lens group,
f1 is defined as a focal length of said first lens group,
ZRb1 is defined as a coordinate in the optical axis direction at a height corresponding to Yb from the optical axis of an object-side paraxial curvature surface of said positive lens in said third lens group,
ZRb2 is defined as a coordinate in the optical axis direction at a height corresponding to Yb from the optical axis of an image-side paraxial curvature surface of said positive lens in said third lens group,
ZAb1 is defined as a coordinate in the optical axis direction at a height corresponding to Yb from the optical axis of an object-side aspherical surface of said positive lens in said third lens group,
ZAb2 is defined as a coordinate in the optical axis direction at a height corresponding to Yb from the optical axis of an image-side aspherical surface of said positive lens in said third lens group,
Cb1 is defined as a paraxial curvature of the object-side aspherical surface of said positive lens in said third lens group;
Cb1 is defined as a paraxial curvature of the image-side aspherical surface of said positive lens in said third lens group;
Nb is defined as a refractive index to the e-line of said positive lens in said third lens group, and
f3 is defined as a focal length of said third lens group.

2. The zoom lens according to claim 1, wherein
said second lens group includes two positive lenses and one negative lens.

3. The zoom lens according to claim 1, wherein
at least one surface of a lens in said second lens group has an aspherical surface.

4. The zoom lens according to claim 2, wherein
at least one surface of a lens in said second lens group has an aspherical surface.

5. The zoom lens according to claim 1, wherein
said second lens group can be shifted substantially in the direction perpendicular to the optical axis to shift an image.

6. The zoom lens according to claim 2, wherein
said second lens group can be shifted substantially in the direction perpendicular to the optical axis to shift an image.

7. The zoom lens according to claim 3, wherein
said second lens group can be shifted substantially in the direction perpendicular to the optical axis to shift an image.

8. The zoom lens according to claim 4, wherein
said second lens group can be shifted substantially in the direction perpendicular to the optical axis to shift an image.

9. An image pickup apparatus, comprising a zoom lens and an imaging device that converts an optical image formed by said zoom lens into an electrical signal, wherein
said zoom lens includes a first lens group having negative refractive power, a second lens group having positive refractive power, and a third lens group having positive refractive power which are arranged in order from an object side to an image side, wherein
when a positional lens state is changed from a wide angle end state to a telephoto end state, said second lens group moves toward an object in an optical axis direction and both said first lens group and said third lens group move in the optical axis direction to reduce the spacing between said first lens group and said second lens group and to increase the spacing between said second lens group and said third lens group;
a focusing function performed by movement of the third lens group is performed by the movement of said third lens group in the optical axis direction at the time of changing the object position;
said first lens group includes a negative lens and a positive lens which are arranged in this order from an object side to an image side;
said third lens group includes a positive lens;
both surfaces of said negative lens of said first lens group are aspherical surfaces, respectively;
both surfaces of said positive lens of said third lens group are aspherical surfaces, respectively; and
the following conditional expressions (1) to (4) are satisfied:
0.10<ASPa1<0.36; (1)
−0.05<ASPa2<−0.02; (2)
0<ASPb1<0.20; and (3)
0.04<ASPb2<0.15, wherein (4)
ASPa1=(ZAa1−ZRa1)/{Ca1(Na−1)·f1},
ASPa2=(ZAa2−ZRa2)/{Ca2(1−Na)·f1},
AsPb1=(ZAb1−ZRb1)/{Cb1(Nb−1)·f3},
AsPb2=(ZAb2−ZRb2)/{Cb2(1−Nb)·f3},
Da is defined as a thickness of said negative lens on said optical axis of said first lens group,
Db is defined as a thickness of said positive lens on said optical axis of said third lens group,
Ya=4Da,
Yb=2 Db,
ZRa1 is defined as a coordinate in the optical axis direction at a height corresponding to Ya from the optical axis of an object-side paraxial curvature surface of said negative lens in said first lens group,
ZRa2 is defined as a coordinate in the optical axis direction at a height corresponding to Ya from the optical axis of an image-side paraxial curvature surface of said negative lens in said first lens group,
ZAa1 is defined as a coordinate in the optical axis direction at a height corresponding to Ya from the optical axis of an object-side aspherical surface of said negative lens in said first lens group,
ZAa2 is defined as a coordinate in the optical axis direction at a height corresponding to Ya from the optical axis of an image-side aspherical surface of said negative lens in said first lens group,
Ca1 is defined as a paraxial curvature of the object-side aspherical surface of said negative lens in said first lens group,
Ca2 is defined as a paraxial curvature of the image-side aspherical surface of said negative lens in said first lens group,
Na is defined as a refractive index to the e-line of said negative lens in said first lens group,
f1 is defined as a focal length of said first lens group,
ZRb1 is defined as a coordinate in the optical axis direction at a height corresponding to Yb from the optical axis of an object-side paraxial curvature surface of said positive lens in said third lens group,
ZRb2 is defined as a coordinate in the optical axis direction at a height corresponding to Yb from the optical axis of an image-side paraxial curvature surface of said positive lens in said third lens group,
ZAb1 is defined as a coordinate in the optical axis direction at a height corresponding to Yb from the optical axis of an object-side aspherical surface of said positive lens in said third lens group,
ZAb2 is defined as a coordinate in the optical axis direction at a height corresponding to Yb from the optical axis of an image-side aspherical surface of said positive lens in said third lens group,
Cb1 is defined as a paraxial curvature of the object-side aspherical surface of said positive lens in said third lens group;
Cb1 is defined as a paraxial curvature of the image-side aspherical surface of said positive lens in said third lens group;
Nb is defined as a refractive index to the e-line of said positive lens in said third lens group, and
f3 is defined as a focal length of said third lens group.
